(19) United States
(12) Patent Application Publication
(10) Pub. No.: US 2026/0257488 A1
(43) Pub. Date: Sep. 3, 2026

(54) INKJET PRINTER AND INKJET HEAD

(71) Applicant: BROTHER KOGYO KABUSHIKI KAISHA, Nagoya (JP)

(72) Inventors: Ko MASUOKA, Miyoshi (JP); Katsunori NISHIDA, Nagoya (JP)

(21) Appl. No.: 19/543,311

(22) Filed: Feb. 18, 2026

(30) Foreign Application Priority Data
Feb. 28, 2025 (JP) 2025-031142

(51) Int. Cl. B41J 2/18; B41J 2/165; B41J 2/175

(52) U.S. Cl. CPC B41J 2/18; B41J 2/16505; B41J 2/17563; B41J 2/17596; B41J 2002/16594

(57) ABSTRACT

An inkjet printer includes a first flow path connected to a first nozzle, a second flow path connected to a second nozzle, a first adjusting member disposed in the first flow path, a second adjusting member disposed in the second flow path, a first filter disposed downstream of the first adjusting member, in a first supply direction along flow of a liquid through the first flow path toward the first nozzle, a second filter disposed downstream of the second adjusting member, in a second supply direction along flow of the liquid through the second flow path toward the second nozzle, and a first connection flow path connecting a first connection point and a second connection point each other. The first connection point is positioned between the first adjusting member and the first filter, and the second connection point is positioned between the second adjusting member and the second filter.

### REFERENCE TO RELATED APPLICATIONS

This application claims priority from Japanese Patent Application No. 2025-031142 filed on Feb. 28, 2025. The entire content of the priority application is incorporated herein by reference.

### BACKGROUND ART

In related art, an inkjet recording device is known that includes a plurality of nozzles, a first flow path, a second flow path, and a bypass flow path. The plurality of nozzles eject a liquid. The first flow path is connected to at least one nozzle of the plurality of nozzles. The second flow path is connected to at least one other nozzle of the plurality of nozzles. The bypass flow path connects the first flow path and the second flow path to each other.

The liquid flows through the first flow path toward the nozzle. The liquid flowing through the first flow path toward the nozzle flows from the first flow path toward the second flow path via the bypass flow path. The liquid flowing through the bypass flow path toward the second flow path flows through the second flow path in the opposite direction to the nozzle. Thus, the liquid is circulated.

### SUMMARY

In the above-described inkjet recording device, an adjusting member is conceivably disposed in each of the first flow path and the second flow path. The adjusting member is, for example, a damper for adjusting pressure acting on the nozzle, or is a differential pressure valve for adjusting a flow rate of the liquid to the nozzle.

Furthermore, in order to suppress foreign matter from being ejected from the nozzle, a filter is conceivably disposed in each of the first flow path and the second flow path. In each of the first flow path and the second flow path, the filter is disposed further downstream of the adjusting member.

It is conceivable for the inkjet recording device to circulate the liquid via the adjusting members. To cause the inkjet recording device to circulate the liquid via the adjusting members, the bypass flow path may connect the first flow path and the second flow path to each other at a position downstream of the adjusting member in each of the first flow path and the second flow path. The position downstream of the adjusting member in each of the first flow path and the second flow path includes a position downstream of the filter in each of the first flow path and the second flow path. For example, it is conceivable that the bypass flow path may connect the first flow path and the second flow path to each other at a position downstream of the filter in each of the first flow path and the second flow path.

In the inkjet recording device, for example, a flow path capacity of the adjusting member is conceivably greater than a flow path capacity of downstream of the filter. When the flow path capacity inside the adjusting member is greater than the flow path capacity downstream of the filter, the flow rate of the adjusting member is likely to be greater than the flow rate downstream of the filter.

On the other hand, in the inkjet recording device, for example, a flow path cross-sectional area downstream of the filter is conceivably smaller than a flow path cross-sectional area inside the adjusting member. When the flow path cross-sectional area downstream of the filter is smaller than the flow path cross-sectional area inside the adjusting member, a flow path resistance downstream of the filter is likely to be greater than a flow path resistance inside the adjusting member.

When the flow path resistance downstream of the filter is greater than the flow path resistance inside the adjusting member, the flow rate of the liquid per unit time inside the adjusting member may decrease. When the bypass flow path connects the first flow path and the second flow path to each other at the position downstream of the filter in each of the first flow path and the second flow path, due to the fact that the flow rate of the liquid per unit time inside the adjusting member decreases, the following possibilities may occur. For example, a time period for the circulation may increase, or the liquid may not be sufficiently circulated. In other words, a circulation performance may deteriorate.

An object of the present disclosure is to provide an inkjet printer and an inkjet head that contribute to circulating a liquid, via an adjusting member, while suppressing a deterioration in a circulation performance.

An inkjet printer according to a first aspect of the present disclosure includes a first flow path, a second flow path, a first adjusting member, a second adjusting member, a first filter, a second filter, and a first connection flow path. The first flow path is connected to a first nozzle configured to eject a liquid. The second flow path is connected to a second nozzle configured to eject the liquid. The first adjusting member is a damper or a differential pressure valve disposed in the first flow path. The second adjusting member is a damper or a differential pressure valve disposed in the second flow path. The first filter is disposed downstream of the first adjusting member in a first supply direction in the first flow path. The first supply direction is a direction along flow of the liquid through the first flow path toward the first nozzle. The second filter is disposed downstream of the second adjusting member in a second supply direction in the second flow path. The second supply direction is a direction along flow of the liquid through the second flow path toward the second nozzle. The first connection flow path connects a first connection point and a second connection point to each other. The first connection point is positioned between the first adjusting member and the first filter in the first supply direction in the first flow path. The second connection point is positioned between the second adjusting member and the second filter in the second supply direction in the second flow path.

According to the first aspect, when the liquid is circulated, the liquid flowing in the first supply direction in the first flow path flows through the first connection flow path from the first flow path toward the second flow path, for example. Furthermore, the liquid flowing through the first connection flow path flows through the second flow path in the opposite direction to the second supply direction. Since the first connection point is disposed downstream of the first adjusting member in the first supply direction in the first flow path, and the second connection point is disposed downstream of the second adjusting member in the second supply direction in the second flow path, when the liquid is circulated, the liquid flows through the first adjusting member and the second adjusting member. Furthermore, since the first connection point is disposed upstream of the first filter in the first supply direction in the first flow path, and the second connection point is disposed upstream of the second filter in the second supply direction in the second flow path, a flow rate of the liquid for the circulation is suppressed from becoming insufficient. Thus, the inkjet printer contributes to circulating the liquid via the first adjusting member and the second adjusting member while suppressing a deterioration in a circulation performance.

The inkjet printer may further include an intermediate member. The intermediate member is disposed between the first adjusting member and the first filter in the first supply direction and between the second adjusting member and the second filter in the second supply direction. The intermediate member includes a first partial flow path and a second partial flow path. The first partial flow path is a part of the first flow path. The second partial flow path is a part of the second flow path. The first connection flow path may be formed at the intermediate member.

Since the inkjet printer includes the intermediate member, forming each of the first partial flow path, the second partial flow path, and the first connection flow path using separate members in the inkjet printer can be avoided. Thus, the inkjet printer contributes to reducing a number of components.

In the inkjet printer, the intermediate member may include an end surface having a first downstream end in the first supply direction of the first partial flow path and a second downstream end in the second supply direction of the second partial flow path. The first connection flow path may be formed at the end surface of the intermediate member.

When the first connection flow path is formed inside the intermediate member, a hole in the intermediate member may need to be formed, for example. Since the first connection flow path is formed at the end surface in the intermediate member, forming the hole in the intermediate member to form the first connection flow path can be avoid. Thus, the inkjet printer contributes to facilitating the manufacture of the intermediate member.

In the inkjet printer, the end surface and the first filter may be arranged alongside each other in an order of the end surface and the first filter from upstream to downstream in the first supply direction. The end surface and the second filter may be arranged alongside each other in an order of the end surface and the second filter from upstream to downstream in the second supply direction.

Since the end surface and the first filter are arranged alongside each other in the order of the end surface and the first filter from upstream to downstream in the first supply direction, compared to a case in which the end surface is separated from the first filter, a distance in the first flow path from the first connection point to the first nozzle is suppressed from becoming long. Since the end surface and the second filter are arranged alongside each other in the order of the end surface and the second filter from upstream to downstream in the second supply direction, compared to a case in which the end surface is separated from the second filter, a distance in the second flow path from the second connection point to the second nozzle is suppressed from becoming long. Thus, the inkjet printer contributes to suppressing a flow rate of the liquid to discharge foreign matter inside the first connection flow path from the first nozzle or the second nozzle.

In the inkjet printer, the intermediate member may include a first wall, a second wall, a first connection wall, and a second connection wall. The first wall is a part of the first flow path and protrudes from the end surface. The second wall is a part of the second flow path and protrudes from the end surface. The first connection wall is a part of the first connection flow path and protrudes from the end surface. The second connection wall is a part of the first connection flow path and protrudes from the end surface. When seen from a direction of protrusion of the first wall from the end surface, the first wall may extend from a first point to a second point around a periphery of the first downstream end. When seen from a direction of protrusion of the second wall from the end surface, the second wall may extend from a third point to a fourth point around a periphery of the second downstream end. The first connection wall may be connected to the first wall at the first point and be connected to the second wall at the third point. The second connection wall may be connected to the first wall at the second point and be connected to the second wall at the fourth point. The first connection wall and the second connection wall may face each other with an interval therebetween.

The distance in the first flow path from the first connection point to the first nozzle is further suppressed from becoming long. The distance in the second flow path from the second connection point to the second nozzle is further suppressed from becoming long. Thus, the inkjet printer contributes to suppressing the flow rate of the liquid to discharge the foreign matter inside the first connection flow path from the first nozzle or the second nozzle.

In the inkjet printer, each of the first point and the second point may be positioned at an end of the first wall in a direction from the first wall toward the second wall, and each of the third point and the fourth point may be positioned at an end of the second wall in a direction from the second wall toward the first wall.

The first connection flow path is suppressed from becoming long. Thus, the inkjet printer contributes to suppressing the deterioration in the circulation performance.

In the inkjet printer, a width direction may be a direction along a facing the first connection wall and the second connection wall face each other. The first wall may include a first facing wall and a second facing wall facing each other in the width direction. The second wall may include a third facing wall and a fourth facing wall facing each other in the width direction. A width between the first connection wall and the second connection wall in the width direction may be smaller than a width between the first facing wall and the second facing wall in the width direction, and smaller than a width between the third facing wall and the fourth facing wall in the width direction.

The inkjet printer contributes to causing a ratio of a flow path cross-sectional area of the first connection flow path with respect to a flow path cross-sectional area of each of the first flow path and the second flow path to be smaller.

The inkjet printer may further include a second connection flow path, a circulation pump, and a controller. The second connection flow path connects a third connection point and a fourth connection point to each other. The third connection point is positioned upstream of the first adjusting member in the first supply direction in the first flow path. The fourth connection point is positioned upstream of the second adjusting member in the second supply direction in the second flow path. The circulation pump is provided in a first circulation flow path including the first flow path, the second flow path, the first connection flow path, and the second connection flow path. The controller may drive the circulation pump and perform a circulation processing of causing the liquid to circulate in the first circulation flow path.

The inkjet printer contributes to reliably circulating the liquid in the first circulation flow path by the circulation processing.

The inkjet printer may further include a cap, a waste liquid pump, a first valve, and a second valve. The cap is configured to come into contact with a nozzle surface including the first nozzle and the second nozzle disposed thereon. The cap is also configured to switch between a capped state of covering the first nozzle and the second nozzle, and an uncapped state of being separated from the nozzle surface. The waste liquid pump is provided in a waste liquid flow path connected to the cap. The first valve is disposed upstream of the third connection point in the first supply direction in the first flow path. The second valve is disposed upstream of the fourth connection point in the second supply direction in the second flow path. The controller may drive the waste liquid pump in a state in which the cap is in the capped state and the first valve is open and the second valve is closed, and perform a first supply processing of causing the liquid to flow in the first supply direction in the first flow path. The controller may the waste liquid pump in a state in which the cap is in the capped state and the first valve is closed and the second valve is open, and perform a second supply processing of causing the liquid to flow in the second supply direction in the second flow path. In the circulation processing, the controller may further drives the circulation pump in a state in which the first valve is closed and the second valve is closed, and causes the liquid to circulate in the first circulation flow path.

The circulation processing is performed in the state in which the first valve is closed. Thus, the liquid is suppressed from flowing upstream from the first valve in the first supply direction in the first flow path during the execution of the circulation processing. The circulation processing is performed in the state in which the second valve is closed. Thus, the liquid is suppressed from flowing upstream from the second valve in the second supply direction in the second flow path during the execution of the circulation processing. Thus, the inkjet printer contributes to suppressing the deterioration in the circulation performance.

The inkjet printer may further include a first manifold flow path, a second manifold flow path, and a third connection flow path. The first manifold flow path is disposed downstream of the first filter in the first supply direction in the first flow path, and is configured to guide the liquid flowing in the first supply direction in the first flow path to the first nozzle. The second manifold flow path is disposed downstream of the second filter in the second supply direction in the second flow path, and is configured to guide the liquid flowing in the second supply direction in the second flow path to the second nozzle. The third connection flow path connects the first manifold flow path and the second manifold flow path to each other. In the circulation processing, the controller may drive the circulation pump and causes the liquid to circulate in the first circulation flow path, and causes the liquid to circulate in a second circulation flow path including the first flow path, the second flow path, the second connection flow path, and the third connection flow path.

Compared to a case in which the circulation of the liquid in the first circulation flow path and the circulation of the liquid in the second circulation flow path are performed separately, the inkjet printer contributes to suppressing the deterioration in the circulation performance.

An inkjet head according to a second aspect of the present disclosure includes a first flow path, a second flow path, a first adjusting member, a second adjusting member, a first filter, a second filter, and a first connection flow path. The first flow path is connected to a first nozzle configured to eject a liquid. The second flow path is connected to a second nozzle configured to eject the liquid. The first adjusting member is a damper or a differential pressure valve disposed in the first flow path. The second adjusting member is a damper or a differential pressure valve disposed in the second flow path. The first filter is disposed downstream of the first adjusting member in a first supply direction in the first flow path. The first supply direction is a direction along flow of the liquid through the first flow path toward the first nozzle. The second filter is disposed downstream of the second adjusting member in a second supply direction in the second flow path. The second supply direction is a direction along flow of the liquid through the second flow path toward the second nozzle. The first connection flow path connects a first connection point and a second connection point to each other. The first connection point is positioned between the first adjusting member and the first filter in the first supply direction in the first flow path. The second connection point is positioned between the second adjusting member and the second filter in the second supply direction in the second flow path.

The second aspect contributes to achieving the same effects as those of the first aspect.

### BRIEF DESCRIPTION OF DRAWINGS

FIG. 1 is a perspective view of a printer.

FIG. 2 is a cross-sectional view as seen in the direction of arrows along a line II-II shown in FIG. 1.

FIG. 3 is a perspective view of a head.

FIG. 4 is an exploded perspective view of an internal unit.

FIG. 5 is a cross-sectional view of a nozzle plate cut along a plane orthogonal to the up-down direction and passing through manifolds.

FIG. 6 is a perspective view of an FE joint.

FIG. 7 is a bottom view of the FE joint.

FIG. 8 is a cross-sectional perspective view of the internal unit cut along a plane orthogonal to the front-rear direction and passing through a connection flow path.

FIG. 9 is a configuration diagram of flow paths of the printer.

FIG. 10 is a block diagram showing an electrical configuration of the printer.

FIG. 11 is a flowchart of main processing.

FIG. 12 is a continuing flowchart of the main processing shown in FIG. 11.

### DESCRIPTION

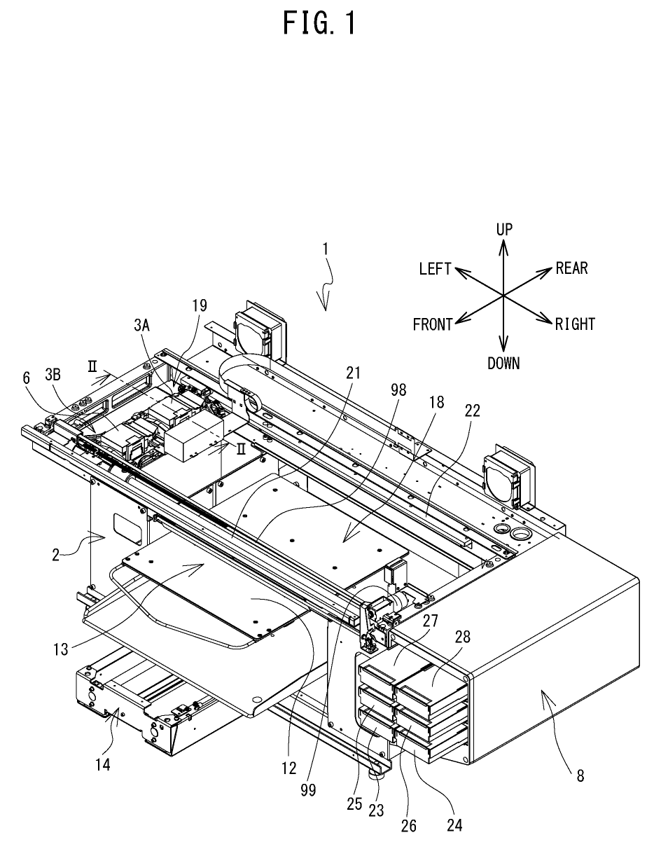

A printer 1 according to an embodiment of the present disclosure will be described with reference to the drawings. An upward direction, a downward direction, a lower left direction, an upper right direction, a lower right direction, and an upper left direction in FIG. 1 are, respectively, an upward direction, a downward direction, a forward direction, a rearward direction, a rightward direction, and a leftward direction of the printer 1. Mechanical elements in the drawings in the present embodiment are shown at actual scale.

The printer 1 shown in FIG. 1 is an inkjet printer. The printer 1 performs printing by ejecting ink onto a print medium. The print medium is a cloth, paper, or the like. The print medium is a T-shirt, for example. The printer 1 can print a color image on the print medium using inks of the five colors of white, black, yellow, cyan, and magenta.

Hereinafter, the white ink of the five colors of ink will be referred to as the “white ink”. Of the five colors of the ink, when the four colors of the black, cyan, yellow, and magenta inks are referred to collectively, or when no particular distinction is made therebetween, the four colors will be referred to as “color ink” or “color inks”. When the white ink and the color inks are referred to collectively, or when no particular distinction is made therebetween, they will simply be referred to as the “ink” or the “inks”.

The white ink is used in the printing as a section representing white in the image, or as a base layer for the color inks. The color inks are used in the printing of the color image by being directly ejected onto the print medium, or by being ejected onto the base layer formed by the white ink.

The overall configuration of the printer 1 will be described with reference to FIG. 1. The printer 1 includes a frame body 2, a platen 12, and an attachment portion 8. The frame body 2 is configured in a lattice shape by a plurality of plates and a plurality of shafts extending in the front-rear direction, the left-right direction, or the up-down direction.

An opening 13 is formed in the frame body 2. The opening 13 is positioned at a central portion of the frame body 2 in a front view. The opening 13 extends in the rearward direction from the front end of the frame body 2.

The platen 12 is disposed inside the opening 13 in a front view. The platen 12 is plate-shaped. The platen 12 extends in the front-rear direction and the left-right direction. The print medium is placed on the platen 12. The platen 12 is supported from below by a support portion 14.

The support portion 14 is fixed to the frame body 2 inside the opening 13. The support portion 14 includes a shaft. The support portion 14 extends in the front-rear direction

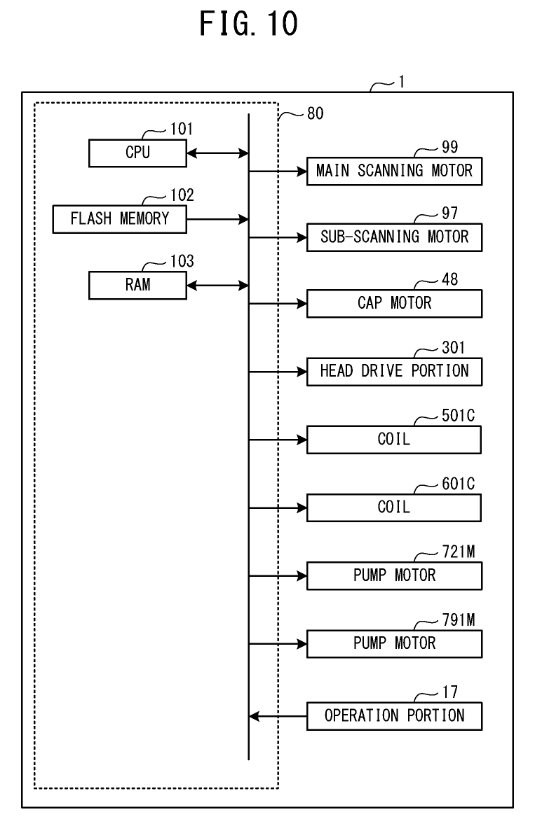

The platen 12 is moved in the front-rear direction along the support portion 14 by driving of a sub-scanning motor 97 shown in FIG. 10. Thus, in the present embodiment, the front-rear direction is a sub-scanning direction.

A pair of guide shafts 21 and 22 are fixed to the upper end of the frame body 2. The guide shaft 21 is disposed at a front end portion of the frame body 2. The guide shaft 21 extends in the left-right direction from the left end to the right end of the frame body 2.

The guide shaft 22 is disposed substantially at the center of the frame body 2 in the front-rear direction. The guide shaft 22 is positioned further to the rear than the guide shaft 21. The guide shaft 22 extends in the left-right direction from the left end to the right end of the frame body 2. The guide shafts 21 and 22 support a carriage 6.

The carriage 6 is plate-shaped. The carriage 6 extends in the front-rear direction and the left-right direction. The carriage 6 extends from the guide shaft 21 to the guide shaft 22.

A drive belt 98 is coupled to the carriage 6. The drive belt 98 is disposed on the guide shaft 21. The drive belt 98 extends in the left-right direction.

The drive belt 98 moves the carriage 6 along the guide shafts 21 and 22 in the left-right direction as a result of driving of a main scanning motor 99 shown in FIG. 10. Thus, in the present embodiment, the left-right direction is a main scanning direction. FIG. 1 shows a state in which the carriage 6 is positioned at the left end of a movement range of the carriage 6.

Heads 3A and 3B are provided at the carriage 6. The head 3A is positioned at a rear portion of the carriage 6. The head 3B is arranged to the front of the head 3A. The heads 3A and 3B are inkjet heads.

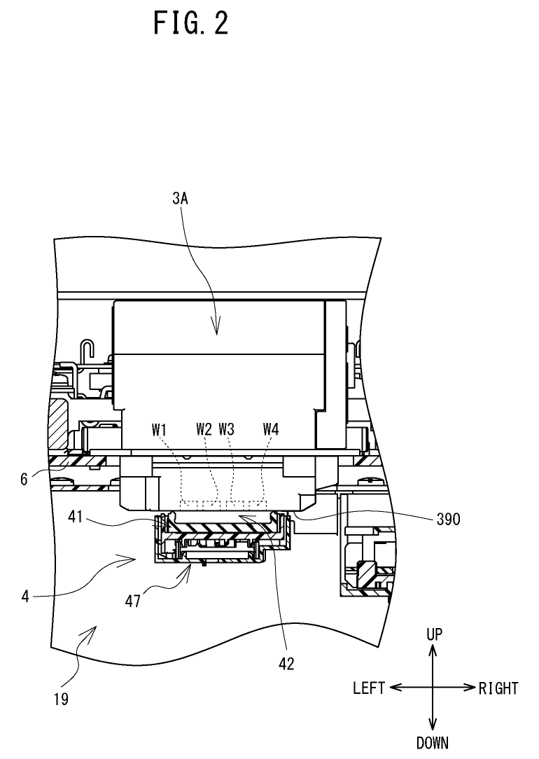

The head 3A includes a nozzle surface 390 shown in FIG. 2. The nozzle surface 390 is disposed at the lower surface of the head 3A.

The nozzle surface 390 includes nozzle groups W1 to W4 shown in FIG. 2. The head 3A ejects the white ink from the nozzle groups W1 to W4. The configuration of the head 3A will be described in detail later.

The head 3B has the same structure as the head 3A. In the present embodiment, the type of ink ejected by the head 3B is different from the type of ink ejected by the head 3A. The head 3B ejects the color inks from nozzle groups of the head 3B.

The attachment portion 8 is box-shaped. The attachment portion 8 is fixed to the right surface of the frame body 2. A plurality of ink pouches 23, 24, 25, 26, 27, and 28 are attached to the attachment portion 8.

Each of the ink pouches 23 to 28 is a cartridge that can be replaced on the attachment portion 8.

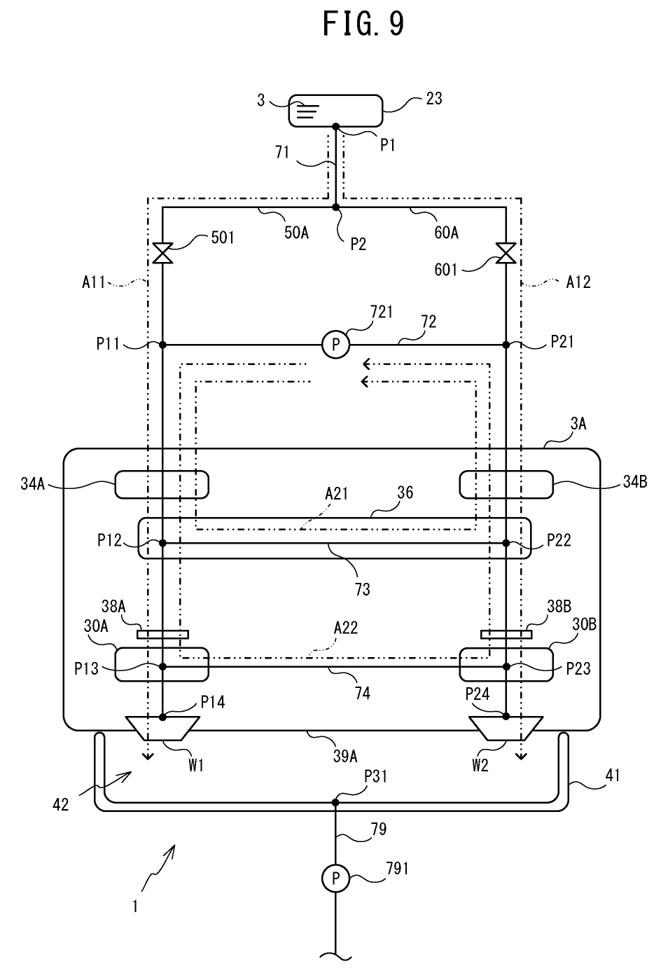

The ink pouch 23 stores white ink 3 shown in FIG. 9 to be supplied to the head 3A. The ink pouch 24 stores the white ink to be supplied to the head 3A.

The ink pouches 25 to 28 respectively store the black, cyan, yellow, and magenta inks to be supplied to the head 3B.

According to the above-described configuration, the heads 3A and 3B move in the left-right direction together with the carriage 6. A region in which a movement path of the platen 12 in the front-rear direction and a movement path of the heads 3A and 3B in the left-right direction overlap each other in the up-down direction will be referred to as a “print region 18”. Of the movement path of the heads 3A and 3B, a region further in the leftward direction than the movement path of the platen 12 will be referred to as a “non-print region 19”. When the heads 3A and 3B and the platen 12 are positioned in the print region 18, the platen 12 faces each of the heads 3A and 3B in the up-down direction.

In the print region 18, the printer 1 conveys the print medium in the front-rear direction and the left-right direction relative to the heads 3A and 3B. In the present embodiment, in the print region 18, the printer 1 moves the platen 12 in the front-rear direction by the driving of the sub-scanning motor 97 shown in FIG. 10, namely, moves the platen 12 in the sub-scanning direction. Furthermore, the printer 1 moves the carriage 6 in the left-right direction using the driving of the main scanning motor 99 shown in FIG. 10, namely, moves the carriage 6 in the main scanning direction.

An operation to move the carriage 6 in the left-right direction while ejecting the white ink from the head 3A or the color inks from the head 3B will be referred to as “ejection scanning”. The printer 1 performs the printing on the print medium by repeating the ejection scanning and the movement of the platen 12 in the front-rear direction. For example, the printer 1 forms the base layer on the print medium by ejecting the white ink from the head 3A in the ejection scanning. The printer 1 prints the color image on the base layer formed on the print medium, by ejecting the color ink from the head 3B in the ejection scanning.

The configuration of the non-print region 19 will be described with reference to FIG. 2. The printer 1 includes a capping mechanism 4. The capping mechanism 4 is provided in the non-print region 19. The capping mechanism 4 includes a cap support portion 47, a cap 41, and one more cap.

The cap support portion 47 is plate-shaped. The cap support portion 47 extends in the front-rear direction and the left-right direction. The cap support portion 47 is moved in the up-down direction by driving of a cap motor 48 shown in FIG. 10.

The cap 41 and the one more cap are fixed to the upper surface of the cap support portion 47. The cap 41 and the one more cap are respectively positioned at the same positions as the heads 3A and 3B in the front-rear direction. The cap 41 and the one more cap are configured by an elastic body made of rubber or the like. The cap 41 and the one more cap are open in the upward direction.

According to the above-described configuration, when the carriage 6 is positioned at the left end of the movement range, in the non-print region 19, the nozzle surface 390 of the head 3A and the nozzle surface of the head 3B are positioned above the cap 41 and the one more cap, respectively. The nozzle surface 390 of the head 3A and the nozzle surface of the head 3B face the cap 41 and the one more cap in the up-down direction. The position of the carriage 6 when the nozzle surface 390 of the head 3A and the nozzle surface of the head 3B respectively face the cap 41 and the one more cap in the up-down direction will be referred to as a “capping position”.

When the cap support portion 47 moves in the upward direction when the carriage 6 is positioned at the capping position, the cap 41 comes into contact, from below, with the nozzle surface 390 while surrounding all of the nozzle groups W1, W2, W3, and W4 in the head 3A. In this way, the cap 41 forms a cap space 42 between the cap 41 and the nozzle surface 390. The cap space 42 is surrounded by the cap 41 and the nozzle surface 390.

Hereinafter, the state in which the cap 41 is in contact with the nozzle surface 390 in the head 3A from below and the cap space 42 is formed will be referred to as a “capped state”. In the capped state, the cap 41 is in contact with the nozzle surface 390 to an extent of being able to maintain a pressure difference between the cap space 42 and the atmosphere.

A state in which the cap 41 is separated in the downward direction from the nozzle surface 390 in the head 3A will be referred to as an “uncapped state”.

In a similar manner to the cap 41, when the cap support portion 47 moves in the upward direction when the carriage 6 is positioned at the capping position, the one more cap comes into contact, from below, with the nozzle surface of the head 3B. The one more cap forms a cap space between the one more cap and the nozzle surface of the head 3B.

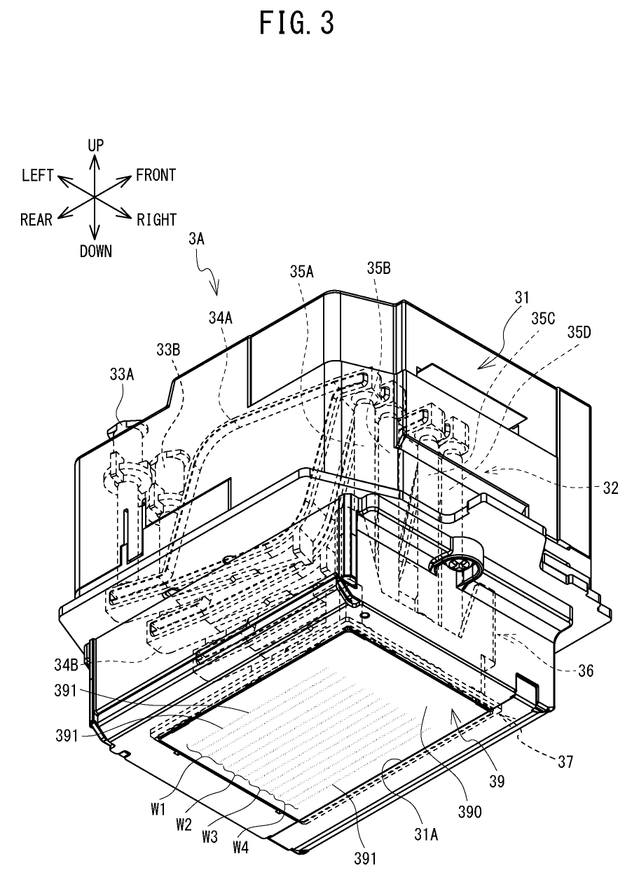

The structural detail of the head 3A will be described in detail with reference to FIGS. 3 to 5. As shown in FIG. 3, the head 3A includes a housing 31 and an internal unit 32. The housing 31 has a cuboid shape. The housing 31 includes an opening 31A. The opening 31A is disposed in the lower surface of the housing 31.

The internal unit 32 is disposed in the housing 31. The internal unit 32 is fixed to the housing 31.

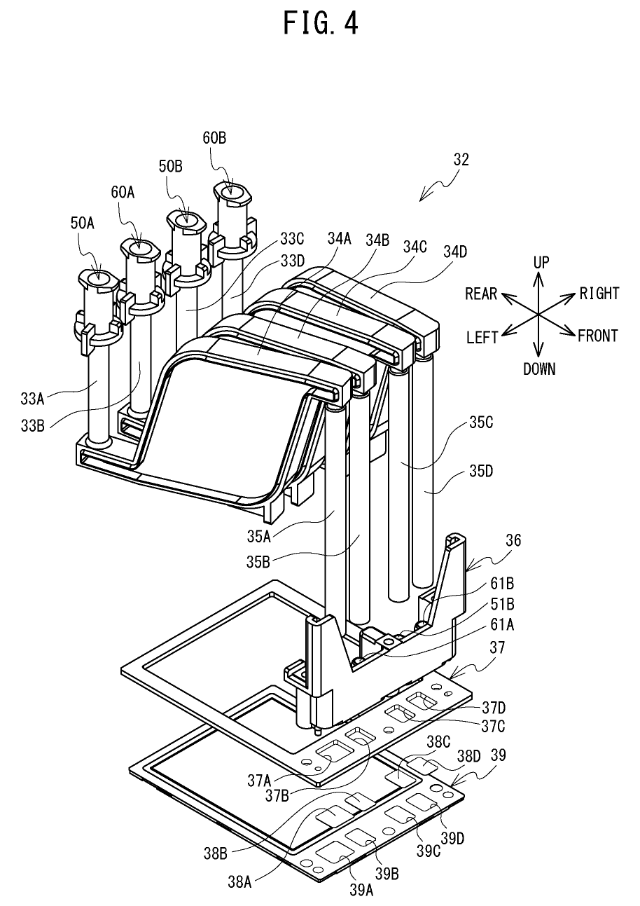

As shown in FIG. 4, the internal unit 32 includes flow paths 33A, 33B, 33C, and 33D, dampers 34A, 34B, 34C, and 34D, flow paths 35A, 35B, 35C, and 35D, a front end joint 36, a front end plate 37, filters 38A, 38B, 38C, and 38D, and the nozzle plate 39. Hereinafter, front end will be denoted by “FE”.

In the present embodiment, “flow path” refers to a wall surface defining a space through which a liquid flows. For example, the flow path may be an inner peripheral wall of a tube, or may be an inner peripheral wall of a through hole formed in a block.

The flow paths 33A, 33B, 33C, and 33D are arranged alongside each other in the order of the flow paths 33A, 33B, 33C, and 33D from the left to the right. Each of the flow paths 33A, 33B, 33C, and 33D is a tube.

The flow path 33A is part of a first flow path 50A to be described later. The flow path 33B is part of a second flow path 60A to be described later. The flow path 33C is part of a first flow path 50B to be described later. The flow path 33D is part of a second flow path 60B to be described later.

As shown in FIG. 3, the upper end of each of the flow paths 33A, 33B, 33C, and 33D is exposed from the upper surface of the housing 31.

As shown in FIG. 4, the damper 34A is connected to the lower end of the flow path 33A. In a similar manner, the dampers 34B, 34C, and 34D are respectively connected to the lower ends of each of the flow paths 33B, 33C, and 33D.

Each of the dampers 34A, 34B, 34C, and 34D is a type of adjusting member. The adjusting member adjusts the pressure acting on the liquid passing through the adjusting member.

The damper 34A includes a damper membrane. The damper membrane is welded to the upstream end of the damper 34A.

The damper membrane is not limited to a particular configuration. In the present embodiment, the damper member is a flexible film. The flexible film is, for example, a resin film. The resin film is configured by polypropylene or polyethylene, for example.

In the present embodiment, the damper 34A absorbs a pressure change to the white ink in the damper 34A, using the damper membrane. The damper 34A may absorb the pressure change to the white ink that occurs due to deformation of the flow path of the white ink during the scanning of the carriage 6. The dampers 34B to 34D have a function and shape that are the same as or correspond to those of the damper 34A, for example, and a description of the dampers 34B to 34D is thus omitted here.

The flow path 35A is connected to the front end of the damper 34A. In a similar manner, each of the flow paths 35B, 35C, and 35D is connected to the front end of the damper 34A. Each of the flow paths 35A, 35B, 35C, and 35D is a tube.

The flow path 35A is a part of the first flow path 50A to be described later. The flow path 35B is part of the second flow path 60A to be described later. The flow path 35C is part of the first flow path 50B to be described later. The flow path 35D is part of the second flow path 60B to be described later.

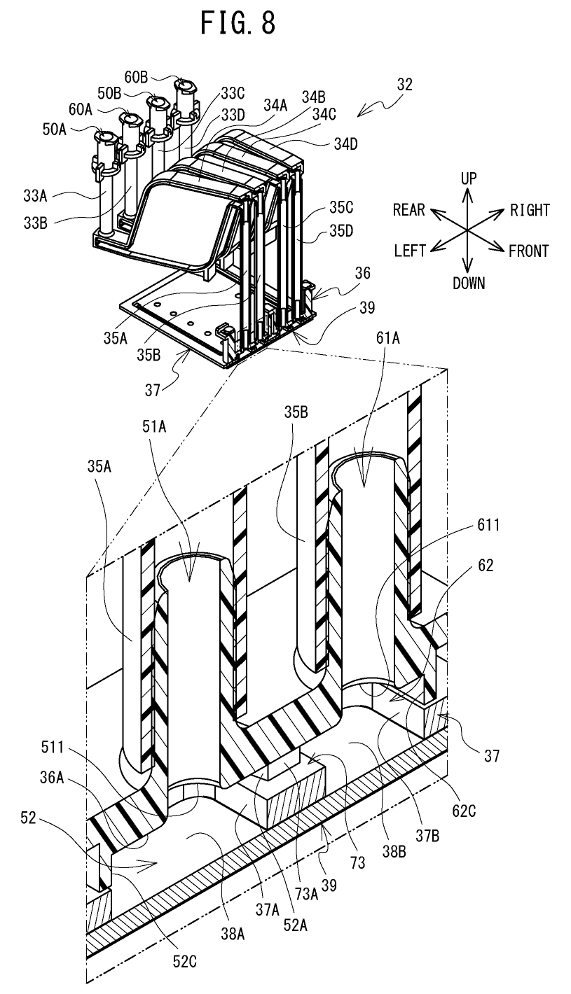

Flow paths 51A, 61A, 51B, and 61B are formed in the FE joint 36. Of the flow paths 51A, 61A, 51B, and 61B, the flow path 51A is not shown in FIG. 4 and is shown in FIG. 8. The flow paths 51A, 61A, 51B, and 61B are arranged alongside each other in the order of the flow paths 51A, 61A, 51B, and 61B from the left to the right. Each of the flow paths 51A, 61A, 51B, and 61B is an inner peripheral wall of a through hole formed in the FE joint 36.

The flow path 51A is a part of the first flow path 50A to be described later. The flow path 61A is part of the second flow path 60A to be described later. The flow path 51B is part of the first flow path 50B to be described later. The flow path 61B is part of the second flow path 60B to be described later.

The lower end of the flow path 35A is connected to the flow path 51A shown in FIG. 8. In a similar manner, the lower ends of the flow paths 35B, 35C, and 35D are respectively connected to the flow paths 61A, 51B, and 61B.

An end surface 36A is formed at the lower end of the FE joint 36. The end surface 36A extends in the front-rear direction and the left-right direction. The end surface 36A is oriented in the downward direction. The shape of the end surface 36A will be described in detail later.

A material of the FE joint 36 is not limited to a particular material, and may be resin, for example.

The FE plate 37 extends in the front-rear direction and the left-right direction. Flow paths 37A, 37B, 37C, and 37D are formed in the front end of the FE plate 37. The flow paths 37A, 37B, 37C, and 37D are arranged alongside each other in the order of the flow paths 37A, 37B, 37C, and 37D from the left to the right.

The flow path 37A is a part of the first flow path 50A to be described later. The flow path 37B is part of the second flow path 60A to be described later. The flow path 37C is part of the first flow path 50B to be described later. The flow path 37D is part of the second flow path 60B to be described later.

A material of the FE plate 37 is not limited to a particular material, and may be a metal, for example. The rigidity of the FE plate 37 is higher than the rigidity of the FE joint 36.

The FE plate 37 is fixed to the end surface 36A of the FE joint 36 by screws, for example.

Each of the filters 38A, 38B, 38C, and 38D is plate-shaped. The filter 38A filters the white ink passing through the filter 38A. In a similar manner to the filter 38A, the filters 38B, 38C, and 38D respectively filter the white ink passing through the filters 38B, 38C, and 38D.

In the present embodiment, each of the filters 38A, 38B, 38C, and 38D is a porous metal piece. Each of the filters 38A, 38B, 38C, and 38D are not limited to a particular type. Each of the filters 38A, 38B, 38C, and 38D may be non-woven cloth, woven cloth, or a resin film, for example. The filters 38A, 38B, 38C, and 38D may be mutually different types.

The nozzle plate 39 extends in the front-rear direction and the left-right direction. The nozzle plate 39 is configured by stacking a plurality of plates. The upper surface of the nozzle plate 39 is fixed to the lower surface of the FE plate 37 by adhesive. The nozzle plate 39 is disposed at the lower end of the housing 31 shown in FIG. 3.

The nozzle plate 39 includes supply ports 39A, 39B, 39C and 39D. Each of the supply ports 39A to 39D is disposed at the upper surface of the nozzle plate 39. Each of the supply ports 39A to 39D is disposed at the front end of the nozzle plate 39. The supply ports 39A to 39D are arranged alongside each other in the order of the supply ports 39A, 39B, 39C and 39D from the left to the right.

The filter 38A is fitted into the supply port 39A. In a similar manner, the filters 38B, 38C, and 38D are respectively fitted into the supply ports 39B, 39C, and 39D.

As shown in FIG. 3, the nozzle plate 39 includes the nozzle surface 390. The nozzle surface 390 is disposed at the lower surface of the nozzle plate 39. The nozzle surface 390 has a planar shape. The nozzle surface 390 extends in the front-rear direction and the left-right direction.

The nozzle surface 390 is disposed higher than the platen 12 shown in FIG. 1. The nozzle surface 390 is exposed in the downward direction from the housing 31 via the opening 31A. The nozzle surface 390 is exposed in the downward direction from the carriage 6 shown in FIG. 1.

The nozzle plate 39 includes a plurality of nozzles 391. The nozzles 391 are disposed in the nozzle surface 390. The plurality of nozzles 391 are openings.

The plurality of nozzles 391 are arranged alongside each other in the front-rear direction in a nozzle column, and a plurality of the nozzle columns are arranged alongside each other in the left-right direction. The plurality of nozzle columns are divided into the nozzle groups W1, W2, W3, and W4. The nozzle groups W1, W2, W3, and W4 are arranged alongside each other in the order of the nozzle groups W1, W2, W3, and W4 from the left to the right.

The nozzle group W1 includes a plurality of first nozzle columns. The plurality of first nozzle columns are connected to the ink pouch 23 via the first flow path 50A to be described later shown in FIGS. 4 and 9. The nozzle group W2 includes a plurality of second nozzle columns. The plurality of second nozzle columns are connected to the ink pouch 23 via the second flow path 60A to be described later shown in FIGS. 4 and 9. Thus, the white ink 3 supplied from the ink pouch 23 is ejected from the nozzle group W1 and the nozzle group W2, respectively.

The nozzle group W3 includes a plurality of third nozzle columns. The plurality of third nozzle columns are connected to the ink pouch 24 via the first flow path 50B shown in FIG. 4. The nozzle group W4 includes a plurality of fourth nozzle columns. The plurality of fourth nozzle columns are connected to the ink pouch 24 via the second flow path 60B shown in FIG. 4. Thus, the white ink supplied from the ink pouch 24 is ejected from the nozzle group W3 and the nozzle group W4, respectively.

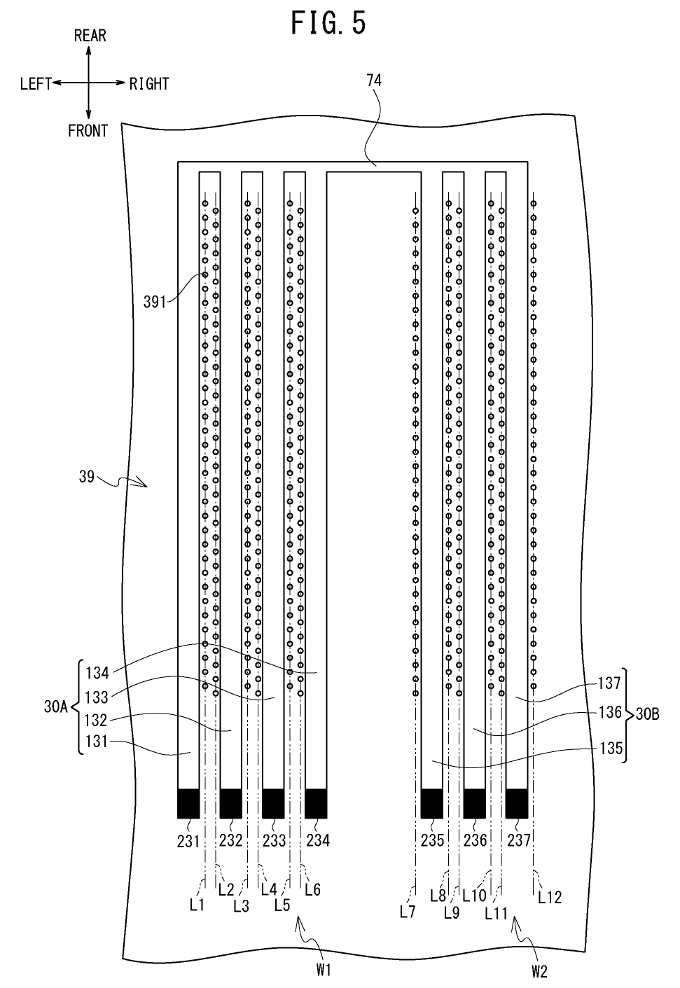

As shown in FIG. 5, the nozzle plate 39 includes manifolds 30A and 30B, and a connection flow path 74. The manifold 30A is a flow path for guiding the white ink that has flowed into the manifold 30A via the supply port 39A to the nozzle group W1. The manifold 30B is a flow path for guiding the white ink that has flowed into the manifold 30B via the supply port 39B to the nozzle group W2.

The manifold 30A includes manifold flow paths 131, 132, 133, and 134. The manifold flow paths 131 to 134 respectively extend from a position further to the front than the front end of the nozzle group W1 to a position further to the rear than the rear end of the nozzle group W1 in the front-rear direction.

In the example in FIG. 5, the nozzle group W1 includes first nozzle columns L1, L2, L3, L4, L5, and L6. The first nozzle columns L1 to L6 and the manifold flow paths 131 to 134 are arranged alongside each other in the order of the manifold flow path 131, the first nozzle columns L1 and L2, the manifold flow path 132, the first nozzle columns L3 and L4, the manifold flow path 133, the first nozzle columns L5 and L6, and the manifold flow path 134 from the left to the right.

The manifold flow path 131 is connected to the first nozzle column L1. The manifold flow path 132 is connected to each of the first nozzle columns L2 and L3. The manifold flow path 133 is connected to each of the first nozzle columns L4 and L5. The manifold flow path 134 is connected to the first nozzle column L6.

The rear ends of each of the manifold flow paths 131 to 134 are connected to each other.

The manifold flow path 131 includes a connection port 231. The connection port 231 is disposed at the front end of the manifold flow path 131. The manifold flow path 131 is connected to the supply port 39A shown in FIG. 4 via the connection port 231.

In a similar manner, the manifold flow paths 132 to 134 respectively include connection ports 232 to 234. The connection ports 232 to 234 are respectively disposed at the front ends of the manifold flow paths 132 to 134. The manifold flow paths 132 to 134 are respectively connected to the supply port 39A shown in FIG. 4 via the connection ports 232 to 234.

The manifold flow path 131 guides the white ink flowing into the manifold flow path 131 from the supply port 39A shown in FIG. 4 via the connection port 231 to the first nozzle column L1. The manifold flow path 132 guides the white ink flowing into the manifold flow path 132 from the supply port 39A shown in FIG. 4 via the connection port 232 to each of the first nozzle columns L2 and L3. The manifold flow path 133 guides the white ink flowing into the manifold flow path 133 from the supply port 39A shown in FIG. 4 via the connection port 233 to each of the first nozzle columns L4 and L5. The manifold flow path 134 guides the white ink flowing into the manifold flow path 134 from the supply port 39A shown in FIG. 4 via the connection port 234 to the first nozzle column L6.

In a similar manner to the manifold 30A, the manifold 30B includes manifold flow paths 135, 136, and 137. Each of the manifold flow paths 135 to 137 extends from a position further to the front than the front end of the nozzle group W2 to a position further to the rear than the rear end of the nozzle group W2 in the front-rear direction.

In the example in FIG. 5, the nozzle group W2 includes second nozzle columns L7, L8, L9, L10, L11, and L12. The second nozzle columns L8 to L12 and the manifold flow paths 135 to 137 are arranged alongside each other in the order of the second nozzle column L7, the manifold flow path 135, the second nozzle columns L8 and L9, the manifold flow path 136, the second nozzle columns L10 and L11, the manifold flow path 137, and the second nozzle column L12 from the left to the right.

The manifold flow path 135 is connected to each of the second nozzle columns L7 and L8. The manifold flow path 136 is connected to each of the second nozzle columns L9 and L10. The manifold flow path 137 is connected to each of the second nozzle columns L11 and L12.

The rear ends of each of the manifold flow paths 135 to 137 are connected to each other.

The manifold flow paths 135 to 137 respectively include connection ports 235 to 237. The connection ports 235 to 237 are respectively disposed at the front ends of the manifold flow paths 135 to 137. The manifold flow paths 135 to 137 are respectively connected to the supply port 39B shown in FIG. 4 via the connection ports 235 to 237.

The manifold flow path 135 guides the white ink flowing into the manifold flow path 135 from the supply port 39B shown in FIG. 4 via the connection port 235 to each of the second nozzle columns L7 and L8. The manifold flow path 136 guides the white ink flowing into the manifold flow path 136 from the supply port 39B shown in FIG. 4 via the connection port 236 to each of the second nozzle columns L9 and L10. The manifold flow path 137 guides the white ink flowing into the manifold flow path 137 from the supply port 39B shown in FIG. 4 via the connection port 237 to each of the second nozzle columns L11 and L12.

The connection flow path 74 is disposed at a rear portion of the nozzle plate 39. The connection flow path 74 extends in the left-right direction. The connection flow path 74 connects the rear ends of each of the manifolds 30A and 30B to each other.

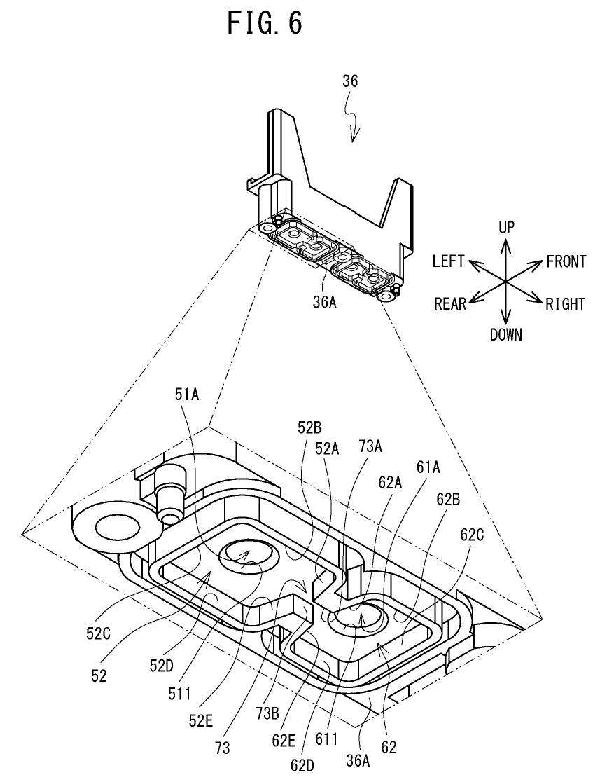

The structural detail of the end surface 36A will be described with reference to FIGS. 6 to 8. As shown in FIG. 6, the FE joint 36 includes flow paths 52 and 62, and a connection flow path 73.

The flow paths 52 and 62, and the connection flow path 73 are disposed at the end surface 36A. The flow paths 52 and 62, and the connection flow path 73 are disposed further in the leftward direction than the center, in the left-right direction, of the end surface 36A. The flow paths 52 and 62, and the connection flow path 73 are arranged alongside each other in the order of the flow path 52, the connection flow path 73, and the flow path 62 from the left to the right.

The flow path 35C and the flow path 35D, and another two flow paths and connection flow path respectively connecting the flow path 35C and the flow path 35D are disposed further to the rightward direction than the center, in the left-right direction, of the end surface 36A. Each of the other two flow paths and connection flow path have a function and shape that are the same as or correspond to those of the flow paths 52 and 62, and the connection flow path 73, and a description of the two other flow paths and the connection flow path is thus omitted here.

The flow path 52 is a part of the first flow path 50A to be described later shown in FIG. 9. The flow path 52 includes walls 52A, 52B, 52C, 52D, and 52E. Each of the walls 52A, 52B, 52C, 52D, and 52E protrudes in the downward direction from the end surface 36A.

The flow path 62 is a part of the second flow path 60A to be described later shown in FIG. 9. The flow path 62 includes walls 62A, 62B, 62C, 62D, and 62E. Each of the walls 62A, 62B, 62C, 62D, and 62E protrudes in the downward direction from the end surface 36A.

The connection flow path 73 connects the flow path 52 and the flow path 62 to each other. The connection flow path 73 includes walls 73A, 73B, the end surface 36A, and the upper surface of the FE plate 37. Each of the walls 73A and 73B protrudes in the downward direction from the end surface 36A.

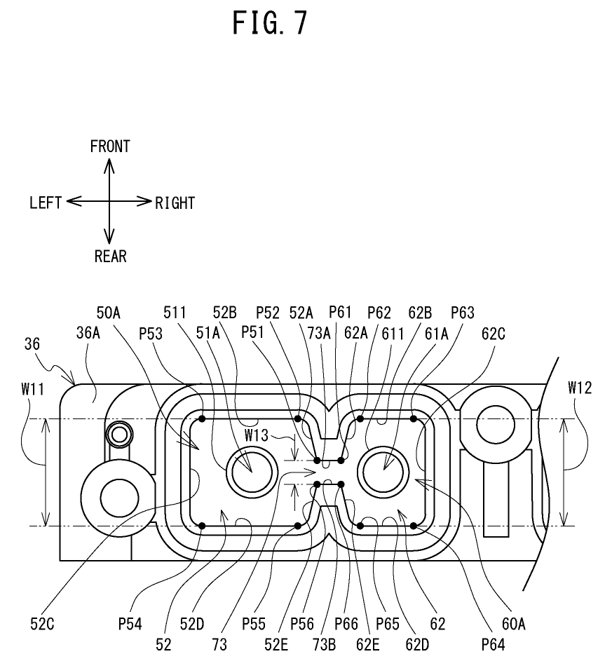

In FIG. 7, each of points P51, P52, P53, P54, P55, P56, P61, P62, P63, P64, P65, and P66 indicates positions on the end surface 36A when seen from below.

As shown in FIG. 7, the point P51 is disposed at the center, in the front-rear direction, of the end surface 36A. The point P52 is disposed to the front of the point P51. The wall 52A extends in the front-rear direction from the point P51 to the point P52.

The point P53 is disposed to the left of the point P52. The wall 52B connects to the wall 52A at the point P52. The wall 52B extends in the left-right direction from the point P52 to the point P53.

The point P54 is disposed to the rear of the point P53. The wall 52C connects to the wall 52B at the point P53. The wall 52C extends in the front-rear direction from the point P53 to the point P54.

The point P55 is disposed to the right of the point P54. The wall 52D connects to the wall 52C at the point P54. The wall 52D extends in the left-right direction from the point P54 to the point P55.

The point P56 is disposed to the front of the point P55. The point P56 is separated in the rearward direction from the point P51. The wall 52E connects to the wall 52D at the point P55. The wall 52E extends in the front-rear direction from the point P55 to the point P56.

According to the above-described configuration, as seen from below, the flow path 52 extends from the point P51 to the point P56 via the points P52 to P55 in the order of the point P52, the point P53, the point P54, the and the point P55. In the present embodiment, each of the point P51 and the point P56 is positioned at the right end of the flow path 52. In other words, each of the point P51 and the point P56 is positioned at the end of the flow path 52 in a direction from the flow path 52 toward the flow path 62.

The wall 52B and the wall 52D face each other in the front-rear direction with an interval therebetween. The wall 52C, and the wall 52A and the wall 52E face each other in the left-right direction with an interval therebetween. The rear end of the wall 52A and the front end of the wall 52E are separated from each other in the front-rear direction.

The walls 52A, 52B, 52C, 52D, and 52E, which form the flow path 52, are connected to a lower end 511 of the flow path 51A. As seen from below, the flow path 52 is disposed around the periphery of the lower end 511 of the flow path 51A.

The point P61 is disposed to the right of the point P51. The point P62 is disposed to the front of the point P61. The wall 62A extends in the front-rear direction from the point P61 to the point P62.

The point P63 is disposed to the left of the point P62. The wall 62B connects to the wall 62A at the point P62. The wall 62B extends in the left-right direction from the point P62 to the point P63.

The point P64 is disposed to the rear of the point P63. The wall 62C connects to the wall 62B at the point P63. The wall 62C extends in the front-rear direction from the point P63 to the point P64.

The point P65 is disposed to the right of the point P64. The wall 62D connects to the wall 62C at the point P64. The wall 62D extends in the left-right direction from the point P64 to the point P65.

The point P66 is disposed to the front of the point P65. The point P66 is separated from the point P61 in the rearward direction. The wall 62E connects to the wall 62D at the point P65. The wall 62E extends in the front-rear direction from the point P65 to the point P66.

According to the above-described configuration, as seen from below, the flow path 62 extends from the point P61 to the point P66 via the points P62 to P65 in the order of the point P62, the point P63, the point P64, and the point P65. In the present embodiment, each of the point P61 and the point P66 is positioned at the left end of the flow path 62. In other words, each of the point P61 and the point P66 is positioned at the end of the flow path 62 in a direction from the flow path 62 toward the flow path 52.

The wall 62B and the wall 62D face each other in the front-rear direction with an interval therebetween. The wall 62C, and the wall 62A and the wall 62E face each other in the left-right direction with an interval therebetween. The rear end of the wall 62A and the front end of the wall 62E are separated from each other in the front-rear direction.

The walls 62A, 62B, 62C, 62D, and 62E, which form the flow path 62, are connected to a lower end 611 of the flow path 61A. As seen from below, the flow path 62 is disposed around the periphery of the lower end 611 of the flow path 61A.

The wall 73A connects to the wall 52A at the point P51. The wall 73A extends in the left-right direction from the point P51 to the point P61. The wall 73A connects to the wall 62A at the point P61.

The wall 73B connects to the wall 52E at the point P56. The wall 73B extends in the left-right direction from the point P56 to the point P66. The wall 73B connects to the wall 62E at the point P66.

The wall 73A and the wall 73B faces each other in the front-rear direction with an interval therebetween.

A width W13 in the front-rear direction between the wall 73A and the wall 73B is smaller than a width W11 in the front-rear direction between the wall 52B and the wall 52D. The width W13 in the front-rear direction between the wall 73A and the wall 73B is smaller than a width W12 in the front-rear direction between the wall 62B and the wall 62D.

As shown in FIG. 8, the lower end of the flow path 52, namely, the lower ends of each of the walls 52A to 52E are in surface contact with the upper surface of the FE plate 37. The FE plate 37 seals the flow path 52 such that the white ink does not leak out from between each of the walls 52A to 52E and the FE plate 37.

The lower end of the flow path 62, namely, the lower ends of each of the walls 62A to 62E are in surface contact with the upper surface of the FE plate 37. The FE plate 37 seals the flow path 62 such that the white ink does not leak out from between each of the walls 62A to 62E and the FE plate 37.

The lower end of the connection flow path 73, namely the lower ends of each of the walls 73A and 73B are in surface contact with the upper surface of the FE plate 37. The FE plate 37 seals the connection flow path 73 such that the white ink does not leak out from between each of the walls 73A and 73B and the FE plate 37.

The end surface 36A is disposed above each of the filters 38A and 38B, and the filters 38C and 38D shown in FIG. 4. In the up-down direction, the end surface 36A is arranged alongside each of the filters 38A and 38B, and the filters 38C and 38D shown in FIG. 4. In other words, the end surface 36A and the filter 38A are arranged alongside each other in the order of the end surface 36A and the filter 38A from the top to the bottom. The end surface 36A and the filter 38B are arranged alongside each other in the order of the end surface 36A and the filter 38B from the top to the bottom. The end surface 36A and the filter 38C are arranged alongside each other in the order of the end surface 36A and the filter 38C from the top to the bottom. The end surface 36A and the filter 38D are arranged alongside each other in the order of the end surface 36A and the filter 38D from the top to the bottom.

In the present embodiment, “one member and another member are arranged alongside each other in the order of the one member and the other member from one direction to another direction” means that, when the one member is projected from the position thereof in the one direction toward the other direction, part or all of a plane of projection of the one member is projected onto the other member. For example, “the end surface 36A and the filter 38A are arranged alongside each other in the order of the end surface 36A and the filter 38A from the top to the bottom” means that when the end surface 36A is projected in the downward direction from above, part or all of the plane of projection of the end surface 36A is formed on the filter 38A.

The configuration of the flow paths of the printer 1 will be described with reference to FIG. 9. The printer 1 includes connection flow paths 71, 72, the connection flow paths 73 and 74, the first flow path 50A and the second flow path 60A.

The connection flow path 71 is connected to the ink pouch 23 at a point P1. The connection flow path 71 extends from the point P1 to a point P2. The connection flow path 71 branches into the first flow path 50A and the second flow path 60A at the point P2. In other words, the first flow path 50A is connected to the connection flow path 71 at the point P2, and the second flow path 60A is connected to the connection flow path 71 at the point P2.

The first flow path 50A is connected to the ink pouch 23 via the connection flow path 71. The first flow path 50A extends from the point P2 to a point P14. The first flow path 50A is connected to the nozzle group W1 at the point P14.

The second flow path 60A is connected to the ink pouch 23 via the connection flow path 71. The second flow path 60A extends from the point P2 to a point P24. The second flow path 60A is connected to the nozzle group W2 at the point P24.

The damper 34A is disposed in the first flow path 50A. The filter 38A is disposed in the first flow path 50A. The manifold 30A is disposed in the first flow path 50A.

The damper 34B is disposed in the second flow path 60A. The filter 38B is disposed in the second flow path 60A. The manifold 30B is disposed in the second flow path 60A.

A first supply direction indicated by an arrow A11 and a second supply direction indicated by an arrow A12 will be defined. The first supply direction is a direction in which the white ink 3 flows through the first flow path 50A toward the nozzle group W1. In the present embodiment, the first supply direction is from the point P2 to the point P14 in the first flow path 50A.

The second supply direction is a direction in which the white ink 3 flows through the second flow path 60A toward the nozzle group W2. In the present embodiment, the second supply direction is from the point P2 to the point P24 in the second flow path 60A.

A point P11, a point P12, and a point P13 are disposed on the first flow path 50A. The point P11, the point P12, and the point P13 are arranged alongside each other in the order of the point P11, the point P12, and the point P13 from upstream to downstream in the first supply direction indicated by the arrow A11.

In the first supply direction indicated by the arrow A11, the point P11 is positioned further upstream than the damper 34A. In the present embodiment, in the first supply direction indicated by the arrow A11, the point P11 is positioned further upstream than the head 3A.

In the first supply direction indicated by the arrow A11, the point P12 is positioned between the damper 34A and the filter 38A.

A point P21, a point P22, and a point P23 are disposed on the second flow path 60A. The point P21, the point P22, and the point P23 are arranged alongside each other in the order of the point P21, the point P22, and the point P23 from upstream to downstream in the second supply direction indicated by the arrow A12.

In the second supply direction indicated by the arrow A21, the point P21 is positioned further upstream than the damper 34B. In the present embodiment, in the second supply direction indicated by the arrow A21, the point P21 is positioned further upstream than the head 3A.

In the second supply direction indicated by the arrow A21, the point P22 is positioned between the damper 34B and the filter 38B.

The connection flow path 72 is connected to the first flow path 50A at the point P11. The connection flow path 72 extends from the point P11 to the point P21. The connection flow path 72 is connected to the second flow path 60A at the point P21.

The connection flow path 73 is connected to the first flow path 50A at the point P12. The connection flow path 73 extends from the point P12 to the point P22. The connection flow path 73 is connected to the second flow path 60A at the point P22. In other words, the FE joint 36 is disposed between the damper 34A and the filter 38A in the first supply direction indicated by the arrow A11, and is disposed between the damper 34B and the filter 38B in the second supply direction indicated by the arrow A12.

The connection flow path 74 is connected to the manifold 30A at the point P13. The connection flow path 74 extends from the point P13 to the point P23. The connection flow path 74 is connected to the manifold 30B at the point P23.

In the first supply direction indicated by the arrow A11, the manifold 30A is disposed further downstream than the filter 38A. In the second supply direction indicated by the arrow A12, the manifold 30B is disposed further downstream than the filter 38B.

The printer 1 includes a first valve 501, a second valve 601, and a circulation pump 721. Each of the first valve 501 and the second valve 601 is a solenoid valve, for example.

In the first supply direction indicated by the arrow A11, the first valve 501 is disposed further upstream than the point P11 of the first flow path 50A. When the first valve 501 is in an open state, in the first flow path 50A, the flow of the white ink 3 from one of the point P2 or the point P11 toward the other thereof via the first valve 501 is allowed. When the first valve 501 is in a closed state, in the first flow path 50A, the flow of the white ink 3 from one of the point P2 or the point P11 toward the other thereof via the first valve 501 is blocked.

In the second supply direction indicated by the arrow A12, the second valve 601 is disposed further upstream than the point P21 of the second flow path 60A. When the second valve 601 is in an open state, in the second flow path 60A, the flow of the white ink 3 from one of the point P2 or the point P21 toward the other thereof via the second valve 601 is allowed. When the second valve 601 is in a closed state, in the second flow path 60A, the flow of the white ink 3 from one of the point P2 or the point P21 toward the other thereof via the second valve 601 is blocked.

The circulation pump 721 is disposed in the connection flow path 72. The circulation pump 721 is driven by a pump motor 721M shown in FIG. 10, and causes the white ink 3 to flow in the connection flow path 72 from one of the point P11 or the point P12 toward the other thereof. In the present embodiment, the circulation pump 721 causes the white ink 3 to flow in the connection flow path 72 from the point P21 toward the point P11.

A first circulation flow path indicated by an arrow A21 and a second circulation flow path indicated by an arrow A22 will be defined. The first circulation flow path includes the first flow path 50A, the second flow path 60A, the connection flow path 73, and the connection flow path 72. The first circulation flow path is one of the flow paths when the white ink 3 is circulated by the driving of the circulation pump 721.

The second circulation flow path includes the first flow path 50A, the second flow path 60A, the connection flow path 72, and the connection flow path 73. The second circulation flow path is another one of the flow paths when the white ink 3 is circulated by the driving of the circulation pump 721.

The printer 1 includes a waste liquid flow path 79 and a waste liquid pump 791. The waste liquid flow path 79 is connected to the cap 41 at a point P31. The waste liquid flow path 79 extends from the point P31 to a waste liquid tank.

The waste liquid pump 791 is disposed in the waste liquid flow path 79. The waste liquid pump 791 is driven by a pump motor 791M shown in FIG. 10, and causes air or waste liquid inside the cap space 42 to flow in the waste liquid flow path 79 from the point P31 toward the waste liquid tank.

The printer 1 includes the plurality of connection flow paths, the first flow path 50B shown in FIG. 4, and the second flow path 60B shown in FIG. 4. A further plurality of connection flow paths, the first flow path 50B, and the second flow path 60B have functions and shapes that are the same as or correspond to those of the connection flow paths 71 to 73, the first flow path 50A, and the second flow path 60A, respectively, and thus a description of the further plurality of connection flow paths, the first flow path 50B, and the second flow path 60B will be omitted here. In FIG. 9, the further plurality of connection flow paths, the first flow path 50B, and the second flow path 60B are not shown.

For example, the further plurality of connection flow paths, the first flow path 50B, and the second flow path 60B respectively differ from the connection flow paths 71 to 73, the first flow path 50A, and the second flow path 60A in the following points. The first flow path 50B connects the ink pouch 24 and the nozzle group W3 to each other. The second flow path 60B connects the ink pouch 24 and the nozzle group W4 to each other. Each of the further plurality of connection flow paths connects the first flow path 50B and the second flow path 60B to each other.

A correspondence relationship between each of the flow paths shown in FIG. 9 and each of the flow paths shown in FIGS. 4 to 8 will be described. Of the first flow path 50A shown in FIG. 9, in the first supply direction indicated by the arrow A11, the flow path between the point P11 and the damper 34A corresponds to the flow path 33A shown in FIG. 4.

Of the first flow path 50A shown in FIG. 9, in the first supply direction indicated by the arrow A11, the flow path between the damper 34A and the point P12 corresponds to the flow path 35A shown in FIG. 4 and the flow paths 51A and 52 shown in FIG. 8. The lower end 511 of the flow path 51A shown in FIG. 8 is the downstream end of the flow path 51A in the first supply direction indicated by the arrow A11 in FIG. 9.

Of the first flow path 50A shown in FIG. 9, in the first supply direction indicated by the arrow A11, the flow path further downstream than the point P12 and further upstream than the manifold 30A corresponds to the flow path including the flow path 37A and the supply port 39A shown in FIG. 4.

Of the second flow path 60A shown in FIG. 9, in the second supply direction indicated by the arrow A12, the flow path between the point P21 and the damper 34B corresponds to the flow path 33B shown in FIG. 4.

Of the second flow path 60A shown in FIG. 9, in the second supply direction indicated by the arrow A12, the flow path between the damper 34B and the point P22 corresponds to the flow path 35B shown in FIG. 4 and the flow paths 61A and 62 shown in FIG. 8. The lower end 611 of the flow path 61A shown in FIG. 8 is the downstream end of the flow path 61A in the second supply direction indicated by the arrow A12 in FIG. 9.

Of the second flow path 60A shown in FIG. 9, in the second supply direction indicated by the arrow A12, the flow path further downstream than the point P22 and further upstream than the manifold 30B corresponds to the flow path including the flow path 37B and the supply port 39B shown in FIG. 4.

In FIG. 9, the first supply direction indicated by the arrow A11 and the second supply direction indicated by the arrow A12 respectively correspond to the downward direction in FIG. 4, for example. In FIG. 9, the direction opposite to the first supply direction indicated by the arrow A11 and the direction opposite to the second supply direction indicated by the arrow A12 respectively correspond to the upward direction in FIG. 4, for example.

The electrical configuration of the printer 1 will be described with reference to FIG. 10. The printer 1 includes a control board 80. A CPU 101, a flash memory 102, and a RAM 103 are disposed on the control board 80. The CPU 101, the flash memory 102, and the RAM 103 are electrically connected to each other.

The CPU 101 controls the printer 1. The CPU 101 functions as a processor.

The flash memory 102 is a non-volatile memory. The flash memory 102 stores various data. For example, a program is stored in the flash memory 102.

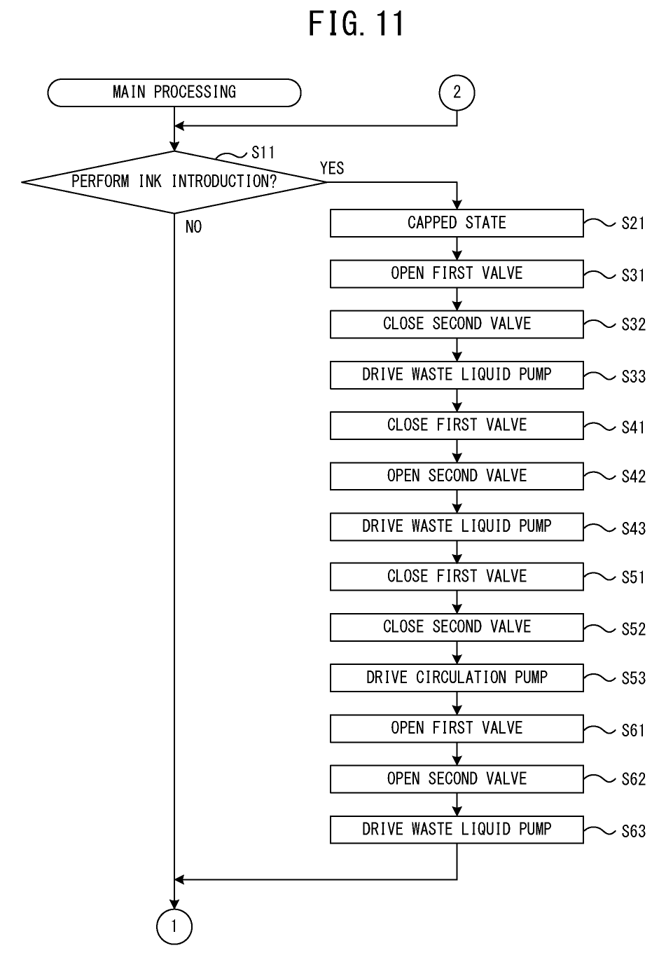

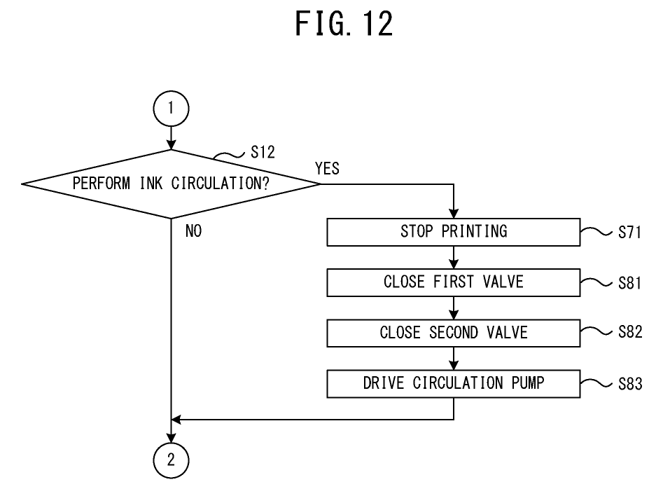

The programs includes computer-readable instructions. The program is executed by the CPU 101. When the program is executed by the CPU 101, the program instructs the CPU 101 to perform various processing. The program includes a control program for executing main processing shown in FIGS. 11 and 12 to be described later.

The RAM 103 temporarily stores various data. The various data include flags used in the main processing, and data acquired, identified, calculated, generated, set, or determined in the main processing.

The main scanning motor 99, the sub-scanning motor 97, the cap motor 48, a head drive portion 301, coils 501C and 601C, the pump motors 721M and 791M, and an operation portion 17 are electrically connected to the CPU 101. The main scanning motor 99, the sub-scanning motor 97, the cap motor 48, the head drive portion 301, the coils 501C and 601C, and the pump motors 721M and 791M are driven under the control of the CPU 101.

The head drive portion 301 is configured by a piezoelectric element or a heating element, for example. The head drive portion 301 is provided at each of the plurality of nozzles 391 shown in FIG. 3 in the head 3A. The head drive portions 301 cause the head 3A to selectively eject the white ink from the plurality of nozzles 391 at a timing of being driven by the CPU 101. Head drive portions for selectively ejecting the color ink are also provided at each of the plurality of nozzles of the head 3B.

The coil 501C is disposed in the first valve 501 shown in FIG. 9. In a state of being driven by the CPU 101, the coil 501C closes the first valve 501. In a state of not being driven by the CPU 101, the coil 501C opens the first valve 501.

The coil 601C is disposed in the second valve 601 shown in FIG. 9. In a state of being driven by the CPU 101, the coil 601C closes the second valve 601. In a state of not being driven by the CPU 101, the coil 601C opens the second valve 601.

The pump motor 721M is disposed in the circulation pump 721 shown in FIG. 9. In a state of being driven by the CPU 101, the pump motor 721M performs suction using the circulation pump 721.

The pump motor 791M is disposed in the waste liquid pump 791 shown in FIG. 9. In a state of being driven by the CPU 101, the pump motor 791M performs suction using the waste liquid pump 791.

The operation portion 17 is a user interface. The operation portion 17 is a touch panel, for example. The operation portion 17 outputs a signal to the CPU 101 in accordance with an operation by a user.

The main processing will be described with reference to FIGS. 11 and 12. When a power supply of the printer 1 is turned on, the CPU 101 executes the main processing by reading out and operating the control program from the flash memory 102. In the main processing, ink introduction and ink circulation are controlled.

The ink introduction is performed in a state in which the first flow path 50A and the second flow path 60A are not filled with the white ink 3, for example. For example, the ink introduction is performed in order to fill the first flow path 50A and the second flow path 60A with the white ink 3. In other words, the ink introduction is an initial introduction of the white ink 3, for example.

The ink circulation is performed in a state in which the first flow path 50A and the second flow path 60A are filled with the white ink 3, for example. The ink circulation is performed in order to resolve a state in which the white ink 3 is not uniformly distributed in the first flow path 50A and the second flow path 60A, for example.

As shown in FIG. 11, when the main processing is started, the CPU 101 determines whether to perform the ink introduction (S11). A timing to perform the ink introduction is not limited to a particular timing. For example, the user operates the operation portion 17 shown in FIG. 10 and inputs, to the printer 1, an introduction command to perform the ink introduction.

When the CPU 101 has not acquired the introduction command, the CPU 101 does not perform the ink introduction. When the CPU 101 does not perform the ink introduction (no at S11), the CPU 101 shifts the processing to a determination at step S12 shown in FIG. 12.

When the CPU 101 has received the introduction command, the CPU 101 performs the ink introduction. When the CPU 101 performs the ink introduction (yes at S11), the CPU 101 switches the cap 41 from the uncapped state to the capped state shown in FIG. 2 (S21).

In the present embodiment, the CPU 101 raises the cap support portion 47 shown in FIG. 2. The cap 41 comes into contact with the nozzle surface 390 of the head 3A, and forms the cap space 42. By forming the cap space 42 between the cap 41 and the nozzle surface 390, the cap 41 is switched from the uncapped state to the capped state shown in FIG. 2. The CPU 101 performs the following processing in the capped state.

The CPU 101 opens the first valve 501 shown in FIG. 9 (S31). The CPU 101 closes the second valve 601 shown in FIG. 9 (S32). By the processing at S31 and S32, a state is obtained in which the first valve 501 is open and the second valve 601 is closed.

In the state in which the first valve 501 is open and the second valve 601 is closed, the CPU 101 drives the waste liquid pump 791 shown in FIG. 9 (S33).

As shown in FIG. 9, since this is the capped state, when the processing at S33 shown in FIG. 11 is performed, the waste liquid pump 791 sucks the white ink 3 from the ink pouch 23 via the first flow path 50A. In other words, as indicated by the arrow A11, the white ink 3 inside the ink pouch 23 flows through the connection flow path 71 from the point P1 toward the point P2. Furthermore, the white ink 3 flows through the first flow path 50A from the point P2 toward point P14.

In the processing at S33 shown in FIG. 11, when the CPU 101 drives the waste liquid pump 791 shown in FIG. 9 for a first predetermined amount, the CPU 101 stops the driving of the waste liquid pump 791.

The first predetermined amount is not limited to a particular drive amount. For example, the first predetermined amount is a drive amount to an extent at which the first flow path 50A is filled with the white ink 3. For example, as the first predetermined amount, a predetermined time period or a predetermined number of rotations over which the waste liquid pump 791 is driven is stored in advance in the flash memory 102.

As shown in FIG. 11, the CPU 101 closes the first valve 501 shown in FIG. 9 (S41). The CPU 101 opens the second valve 601 shown in FIG. 9 (S42). By the processing at S41 and S42, a state is obtained in which the first valve 501 is closed and the second valve 601 is open.

In the state in which the first valve 501 is closed and the second valve 601 is open, the CPU 101 drives the waste liquid pump 791 shown in FIG. 9 (S43).

As shown in FIG. 9, since this is the capped state, when the processing at S43 shown in FIG. 11 is performed, the waste liquid pump 791 sucks the white ink 3 from the ink pouch 23 via the second flow path 60A. In other words, as indicated by the arrow A12, the white ink 3 inside the ink pouch 23 flows through the connection flow path 71 from the point P1 toward the point P2. Furthermore, the white ink 3 flows through the second flow path 60A from the point P2 toward point P24.

In the processing at S43 shown in FIG. 11, when the CPU 101 drives the waste liquid pump 791 for a second predetermined amount, the CPU 101 stops the driving of the waste liquid pump 791.

The second predetermined amount is not limited to a particular drive amount. For example, the second predetermined amount is a drive amount to an extent at which the second flow path 60A is filled with the white ink 3. The second predetermined amount may be the same as the first predetermined amount, may be greater than the first predetermined amount, or may be less than the first predetermined amount. For example, as the second predetermined amount, a predetermined time period or a predetermined number of rotations over which the waste liquid pump 791 is driven is stored in advance in the flash memory 102.

As shown in FIG. 11, the CPU 101 closes the first valve 501 shown in FIG. 9 (S51). The CPU 101 closes the second valve 601 shown in FIG. 9 (S52). By the processing at S51 and S52, a state is obtained in which the first valve 501 is closed and the second valve 601 is closed.

In the state in which the first valve 501 is closed and the second valve 601 is closed, the CPU 101 drives the circulation pump 721 shown in FIG. 9 (S53).

As shown in FIG. 9, when the processing at S53 shown in FIG. 11 is performed, the circulation pump 721 circulates the white ink 3 through the first circulation flow path indicated by the arrow A21, and circulates the white ink 3 through the second circulation flow path indicated by the arrow A22. In the present embodiment, when the processing at S53 shown in FIG. 11 is performed, the circulation of the white ink 3 in the first circulation flow path indicated by the arrow A21 and the circulation of the white ink 3 in the second circulation flow path indicated by the arrow A22 are performed simultaneously. The suction by the circulation pump 721 causes the white ink 3 to flow as described below.

The white ink 3 flows through the connection flow path 72 from the point P21 toward the point P11. Since the first valve 501 is closed, the white ink 3 flowing through the connection flow path 72 from the point P21 toward the point P11 flows through the first flow path 50A from the point P11 toward the point P12.

On the other hand, since the second valve 601 is closed, at the point P21, the white ink 3 flows through the second flow path 60A from the point P22. At the point P22, the white ink 3 flows from the point P12 via the connection flow path 73, and the white ink 3 flows from the point P23 via the second flow path 60A.

At the point P23, the white ink 3 flows from the point P13 via the connection flow path 74. At the point P13, the white ink 3 flows from the point P12 via the first flow path 50A.

A ratio between an amount of the white ink 3 flowing through the connection flow path 73 from the point P12 toward the point P22 and an amount of the white ink 3 flowing through the second flow path 60A from the point P23 toward the point P22 is determined by a ratio between a flow path resistance of the connection flow path 73 from the point P12 to the point P22 and a flow path resistance of the first flow path 50A, the connection flow path 74, and the second flow path 60A from the point P12 to the point P22 via the point P13 and the point P23. In the present embodiment, the flow path resistance of the connection flow path 73 from the point P12 to the point P22 is smaller than the flow path resistance of the first flow path 50A, the connection flow path 74, and the second flow path 60A from the point P12 to the point P22 via the point P13 and the point P23. Thus, the amount of the white ink 3 flowing through the connection flow path 73 from the point P12 toward the point P22 is greater than the amount of the white ink 3 flowing through the second flow path 60A from the point P23 toward the point P22.

In the present embodiment, the size of the nozzle 391 shown in FIG. 3 is extremely small such that the flow path resistance of the connection flow path 74 with respect to a flow path resistance of the nozzle 391 can be ignored. Furthermore, the size of the nozzle 391 shown in FIG. 3 is extremely small such that the flow path resistance of the first flow path 50A from the point P12 to the point P13 with respect to the flow path resistance of the nozzle 391 can be ignored. Thus, the white ink 3 does not flow from the point P13 to the point P23 via the nozzle group W1, the cap space 42, and the nozzle group W2. In other words, in the present embodiment, in the processing at S53 shown in FIG. 11, the circulation of the white ink 3 via the cap space 42 is not performed.

In the processing at S33 and S43 shown in FIG. 11, the white ink 3 does not easily flow through the connection flow paths 72, 73, and 74. Since the white ink 3 does not easily flow through the connection flow paths 72, 73, and 74, air in the connection flow paths 72, 73, and 74 easily accumulates in the connection flow paths 72, 73, and 74.

By the processing at S53 shown in FIG. 11, the connection flow paths 72, 73, and 74 are filled with the white ink 3. Since the white ink 3 flows through the connection flow paths 72, 73, and 74, the air in the connection flow paths 72, 73, and 74 flows from the connection flow paths 72, 73, and 74 to the first flow path 50A or the second flow path 60A. In other words, the air is suppressed from accumulating in the connection flow paths 72, 73, and 74.

By the processing at S53 shown in FIG. 11, when the CPU 101 drives the circulation pump 721 by a third predetermined amount, the CPU 101 stops the driving of the circulation pump 721.

The third predetermined amount is not limited to a particular drive amount. For example, the third predetermined amount is a drive amount to an extent at which the air of the connection flow path 72 is moved to the first flow path 50A or to the second flow path 60A. For example, as the third predetermined amount, a predetermined time period or a predetermined number of rotations over which the circulation pump 721 is driven is stored in advance in the flash memory 102.

As shown in FIG. 11, the CPU 101 opens the first valve 501 shown in FIG. 9 (S61). The CPU 101 opens the second valve 601 shown in FIG. 9 (S62). By the processing at S61 and S62, a state is obtained in which the first valve 501 is open and the second valve 601 is open.

In the state in which the first valve 501 is open and the second valve 601 is open, the CPU 101 drives the waste liquid pump 791 shown in FIG. 9 (S63).

As shown in FIG. 9, since this is the capped state, when the processing at S63 shown in FIG. 11 is performed, the waste liquid pump 791 sucks the white ink 3 from the ink pouch 23 via the first flow path 50A and the second flow path 60A, respectively. As indicated by the arrow A11 and the arrow A12, the white ink 3 is discharged from the nozzle group W1 and the nozzle group W2, respectively. In other words, the white ink 3 is purged by the processing at S63.

In the processing at S63 shown in FIG. 11, when the CPU 101 drives the waste liquid pump 791 by a fourth predetermined amount, the CPU 101 stops the driving of the waste liquid pump 791.

The fourth predetermined amount is not limited to a particular drive amount. For example, the fourth predetermined amount is a drive amount to an extent at which the air of the first flow path 50A is discharged from the nozzle group W1, and the air of the second flow path 60A is discharged from the nozzle group W2. The fourth predetermined amount may be the same as the first predetermined amount or the second predetermined amount, may be greater than the first predetermined amount or the second predetermined amount, or may be less than the first predetermined amount or the second predetermined amount. For example, as the fourth predetermined amount, a predetermined time period or a predetermined number of rotations over which the waste liquid pump 791 is driven is stored in advance in the flash memory 102.

As shown in FIG. 11, after the processing at S63, the CPU 101 shifts the processing to the determination at S12 shown in FIG. 12.

As shown in FIG. 12, the CPU 101 determines whether to perform the ink circulation (S12). A timing at which the ink circulation is performed is not limited to a particular timing. For example, the ink circulation is regularly performed. In other words, when a predetermined interval time period has elapsed from a previous ink circulation, the next ink circulation is performed.

For example, when the interval time period has not elapsed, the ink circulation is not yet to be performed. When the ink circulation is not to be performed (no at S12), the CPU 101 returns the processing to S11 shown in FIG. 11.

For example, when the interval time period has elapsed, the ink circulation is performed. When the ink circulation is performed (yes at S12), the CPU 101 stops the printing (S71). The CPU 101 performs the following processing in the state in which the printing is stopped.

The CPU 101 closes the first valve 501 shown in FIG. 9 (S81). The CPU 101 closes the second valve 601 shown in FIG. 9 (S82). By the processing at S81 and S82, the state is obtained in which the first valve 501 is closed and the second valve 601 is closed.

In the state in which the first valve 501 is closed and the second valve 601 is closed, the CPU 101 drives the circulation pump 721 shown in FIG. 9.

As shown in FIG. 9, when the processing at S83 shown in FIG. 12 is performed, in a similar manner to the processing at S53 shown in FIG. 11, the circulation of the white ink 3 in the first circulation flow path indicated by the arrow A21 and the circulation of the white ink 3 in the second circulation flow path indicated by the arrow A22 are performed simultaneously.

In the processing at S83 shown in FIG. 12, when the CPU 101 drives the circulation pump 721 for a fifth predetermined amount, the CPU 101 stops the driving of the circulation pump 721.

The fifth predetermined amount is not limited to a particular drive amount. For example, the fifth predetermined amount is a drive amount sufficient to suppress sedimentation of a sedimentary component of the white ink 3 in the first circulation flow path and the second circulation flow path. The fifth predetermined amount may be the same as the third predetermined amount, may be greater than the third predetermined amount, or may be less than the third predetermined amount. For example, as the fifth predetermined amount, a predetermined time period or a predetermined number of rotations over which the circulation pump 721 is driven is stored in advance in the flash memory 102.

As shown in FIG. 12, after the processing at S83, the CPU 101 returns the processing to the determination at S11 shown in FIG. 11.

Main effects of the above-described embodiment will be described. The above-described embodiment also achieves effects other than the effects described below. The present disclosure is not limited by the effects described below.

In the above-described embodiment, the first flow path 50A is connected to the nozzle group W1. The second flow path 60A is connected to the nozzle group W2.

The damper 34A is disposed in the first flow path 50A. The damper 34B is disposed in the second flow path 60A.

In the first supply direction, the filter 38A is disposed further downstream than the damper 34A in the first flow path 50A. In the second supply direction, the filter 38B is disposed further downstream than the damper 34B in the second flow path 60A.

The connection flow path 73 connects the point P12 and the point P22 to each other. The point P12 is positioned between the damper 34A and the filter 38A in the first supply direction in the first flow path 50A. The point P22 is positioned between the damper 34B and the filter 38B in the second supply direction in the second flow path 60A.

According to the above-described embodiment, when the white ink 3 is circulated, for example, the white ink 3 flowing in the first supply direction in the first flow path 50A flows through the connection flow path 73 from the first flow path 50A toward the second flow path 60A. Furthermore, the white ink 3 flowing through the connection flow path 73 flows through the second flow path 60A in the opposite direction to the second supply direction.

The flow path cross-sectional area of each of the dampers 34A and 34B is larger than the flow path cross-sectional area of the sections of the first flow path 50A and the second flow path 60A other than the dampers 34A and 34B. The sections other than the dampers 34A and 34B are, for example, the flow paths 33A, 33B, 35A and 35B. Since the flow path cross-sectional area of the dampers 34A and 34B is large, air more easily accumulates in the dampers 34A and 34B than in the sections other than the dampers 34A and 34B. The point P12 is disposed further downstream than the damper 34A in the first supply direction in the first flow path 50A, and the point P22 is disposed further downstream than the damper 34B in the second supply direction in the second flow path 60A. Thus, when the white ink 3 is circulated, the white ink 3 flows through the damper 34A and the damper 34B. Thus, the air is suppressed from accumulating in the dampers 34A and 34B.

Furthermore, since the manifold 30A is present in the section of the first flow path 50A further downstream than the filter 38A in the first supply direction, for example, the flow path cross-sectional area of the section further downstream than the filter 38A is generally smaller than that of the section of the first flow path 50A further upstream than the filter 38A in the first supply direction. In a similar manner, the flow path cross-sectional area of the section further downstream than the filter 38B is generally smaller than that of the section of the second flow path 60A further upstream than the filter 38B in the second supply direction. Thus, the flow rate of the white ink 3 in the sections further downstream than the filters 38A and 38B is not easily increased. Thus, when the point P12 is disposed further downstream than the filter 38A in the first supply direction in the first flow path 50A, and the point P22 is disposed further downstream than the filter 38B in the second supply direction in the second flow path 60A, the flow rate of the white ink 3 is likely to become insufficient in the ink circulation. When the flow rate of the white ink 3 is insufficient in the ink circulation, the air is not easily discharged from the dampers 34A and 34B, and the connection flow path 73 , and the sedimentation of the sedimentary component of the white ink 3 in the dampers 34A and 34B, and the connection flow path 73 is not easily resolved.

In the above-described embodiment, since the point P12 is disposed further upstream than the filter 38A in the first supply direction in the first flow path 50A and the point P22 is disposed further upstream than the filter 38B in the second supply direction in the second flow path 60A, the flow rate of the white ink 3 for the ink circulation is suppressed from becoming insufficient. Thus, the printer 1 contributes to causing the air to be more easily discharged from the dampers 34A and 34B and from the connection flow path 73, and to causing the sedimentation of the sedimentary component of the white ink 3 in the dampers 34A and 34B and the connection flow path 73 to be more easily resolved. In other words, the printer 1 contributes to causing the white ink 3 to be circulated via the dampers 34A and 34B while suppressing a deterioration in a circulation performance.

In the above-described embodiment, the FE joint 36 is disposed between the damper 34A and the filter 38A in the first supply direction, and is disposed between the damper 34B and the filter 38B in the second supply direction. The flow path 51A and the flow path 61A are formed in the FE joint 36. The connection flow path 73 is formed in the FE joint 36.

Since the printer 1 includes the FE joint 36, it is not necessary to form the flow path 51A, the flow path 61A, and the connection flow path 73 as separate members, respectively, in the printer 1. Thus, the printer 1 contributes to reducing a number of components.

In the above-described embodiment, in the FE joint 36, the lower end 511 of the flow path 51A and the lower end 611 of the flow path 61A are disposed on the end surface 36A, and the connection flow path 73 is formed at the end surface 36A in the FE joint 36.

When the connection flow path 73 is formed inside the FE joint 36, it is necessary to form a hole in the FE joint 36, for example. Since the connection flow path 73 is formed at the end surface 36A in the FE joint 36, it is not necessary to open the hole in the FE joint 36 to form the connection flow path 73. Thus, the printer 1 contributes to facilitating the manufacture of the FE joint 36.

When the end surface 36A is not arranged alongside each of the filters 38A and 38B, it is conceivable that the end surface 36A is separated from each of the filters 38A and 38B. The more the end surface 36A is separated from each of the filters 38A and 38B, the longer the flow path becomes from the lower end 511 of the flow path 51A and the lower end 611 of the flow path 61A to the respective filters 38A and 38B. When the flow path becomes longer, a capacity of the flow path becomes larger.

In the above-described embodiment, the end surface 36A and the filter 38A are arranged alongside each other in the order of the end surface 36A and the filter 38A from upstream to downstream in the first supply direction. The end surface 36A and the filter 38B are arranged alongside each other in the order of the end surface 36A and the filter 38B from upstream to downstream in the second supply direction.

Since the end surface 36A and the filter 38A are arranged alongside each other in the order of the end surface 36A and the filter 38A from upstream to downstream in the first supply direction, compared to a configuration in which the end surface 36A is separated from the filter 38A, a distance of the first flow path 50A from the point P12 to the nozzle group W1 is suppressed from becoming long. Since the end surface 36A and the filter 38B are arranged alongside each other in the order of the end surface 36A and the filter 38B from upstream to downstream in the second supply direction, compared to a configuration in which the end surface 36A is separated from the filter 38B, a distance of the second flow path 60A from the point P22 to the nozzle group W2 is suppressed from becoming long. Thus, the printer 1 contributes to suppressing the flow rate of the white ink 3 for discharging the foreign matter inside the connection flow path 73 from the nozzle group W1 or the nozzle group W2.

In the above-described embodiment, the flow path 52 protrudes from the end surface 36A. The flow path 62 protrudes from the end surface 36A. The wall 73A protrudes from the end surface 36A. The wall 73B protrudes from the end surface 36A.

As seen from below, the flow path 52 extends from the point P51 to the point P56 around the lower end 511 of the flow path 51A. As seen from below, the flow path 62 extends from the point P61 to the point P66 around the lower end 611 of the flow path 61A. The wall 73A is connected to the flow path 52 at the point P51, and is connects to the flow path 62 at the point P61. The wall 73B is connected to the flow path 52 at the point P56, and is connected to the flow path 62 at the point P66. The wall 73A and the wall 73B face each other with an interval therebetween.

The distance of the first flow path 50A from the point P12 to the nozzle group W1 can further be suppressed from becoming long. The distance of the second flow path 60A from the point P22 to the nozzle group W2 can be further suppressed from becoming long. Thus, the printer 1 contributes to further suppressing the flow rate of the white ink 3 to discharge the foreign matter inside the connection flow path 73 from the nozzle group W1 or the nozzle group W2.

When, for example, the point P51 and the point P56 are positioned at the left end of the flow path 52, it is difficult for the connection flow path 73 to connect the flow path 52 and the flow path 62 to each other in a straight line.

In the above-described embodiment, each of the point P51 and the point P56 is positioned at the end of the flow path 52 in the direction from the flow path 52 toward the flow path 62. Each of the point P61 and the point P66 is positioned at the end of the flow path 62 in the direction from the flow path 62 toward the flow path 52.

Thus, the connection flow path 73 is suppressed from becoming long. In other words, the flow path resistance in the connection flow path 73 is suppressed. Thus, the printer 1 contributes to suppressing the flow rate of the white ink 3 for the circulation from becoming insufficient. In other words, the printer 1 contributes to suppressing the deterioration in the circulation performance.

As described above, the flow path cross-sectional area of the sections further downstream than the filters 38A and 38B is generally small. Thus, the larger the flow path cross-sectional area of the connection flow path 73, the larger the ratio of the flow path cross-sectional area of the connection flow path 73 becomes with respect to the flow path cross-sectional area of the sections further downstream than the filters 38A and 38B. When the ratio becomes larger, in the processing at S53, the white ink 3 flows less easily from the point P23 toward the point P22 via the second flow path 60A.

In the above-described embodiment, the wall 52B and the wall 52D face each other in the front-rear direction. The wall 62B and the wall 62D face each other in the front-rear direction. The width W13 in the front-rear direction between the wall 73A and the wall 73B is smaller than the width W11 in the front-rear direction between the wall 52B and the wall 52D, and is smaller than the width W12 in the front-rear direction between the wall 62B and the wall 62D. Thus, the printer 1 contributes to causing the ratio of the flow path cross-sectional area of the connection flow path 73 with respect to the flow path cross-sectional area of the sections further downstream than the filters 38A and 38B to approach 1. In other words, the printer 1 contributes to suppressing the flow of the white ink 3 from the point P23 to the point P22 via the second flow path 60A from becoming difficult in the processing at S53.

Furthermore, compared to a case in which the width W13 is larger than the width W11 or the width W12, narrow sections of a mold for forming the FE joint 36 are reduced. Thus, the printer 1 contributes to improving the strength of the mold for forming the FE joint 36.

Furthermore, compared to the case in which the width W13 is larger than the width W11 or the width W12, a contact surface area between the end surface 36A and the FE joint 36 is larger. Thus, the printer 1 contributes to making it difficult for the FE plate 37 to be removed from the FE joint 36.

In the above-described embodiment, the connection flow path 72 connects the point P11 and the point P21 to each other. The point P11 is positioned further upstream than the damper 34A in the first supply direction in the first flow path 50A. The point P21 is positioned further upstream than the damper 34B in the second supply direction in the second flow path 60A. The circulation pump 721 is provided in the first circulation flow path. The CPU 101 drives the circulation pump 721 and causes the white ink 3 to circulate in the first circulation flow path (S53 or S83).

The printer 1 contributes to reliably circulating the white ink 3 in the first circulation flow path by the processing at S83.

In the above-described embodiment, the waste liquid pump 791 is disposed in the waste liquid flow path 79. The first valve 501 is disposed further upstream than the point P11 in the first supply direction in the first flow path 50A. The second valve 601 is disposed further upstream than the point P21 in the second supply direction in the second flow path 60A.

The CPU 101 drives the waste liquid pump 791 in the state in which the cap 41 is in the capped state, and the state in which the first valve 501 is open and the second valve 601 is closed, and causes the white ink 3 to flow in the first supply direction in the first flow path 50A (S33). The CPU 101 drives the waste liquid pump 791 in the state in which the cap 41 is in the capped state, and the state in which the first valve 501 is closed and the second valve 601 is open, and causes the white ink 3 to flow in the second supply direction in the second flow path 60A (S43). The CPU 101 further drives the circulation pump 721 in the state in which the first valve 501 is closed and the second valve 601 is closed, and causes the white ink 3 to circulate in the first circulation flow path (S53).

Since the processing at S53 is performed in the state in which the first valve 501 is closed, the white ink 3 is suppressed from flowing upstream from the first valve 501 in the first supply direction in the first flow path 50A during the execution of the processing at S53. The processing at S53 is performed in the state in which the second valve 601 is closed. Thus, the white ink 3 is suppressed from flowing upstream from the second valve 601 in the second supply direction in the second flow path 60A during the execution of the processing at S53. Thus, the printer 1 contributes to suppressing the flow rate of the white ink 3 for the ink circulation from becoming insufficient. In other words, the printer 1 contributes to suppressing the deterioration in the circulation performance.

In the above-described embodiment, the manifold 30A guides the white ink 3 flowing through the first flow path 50A in the first supply direction to the nozzle group W1. The manifold 30B guides the white ink 3 flowing through the second flow path 60A in the second supply direction to the nozzle group W2. The connection flow path 74 connects the manifold 30A and the manifold 30B to each other. The CPU 101 drives the circulation pump 721 and causes the white ink 3 to circulate in the first circulation flow path, and causes the white ink 3 to circulate in in the second circulation flow path (S53 or S83).

In this case, compared to a case in which the circulation of the white ink 3 in the first circulation flow path and the circulation of the white ink 3 in the second circulation flow path are performed separately, the printer 1 contributes to suppressing a time period for the circulation of the white ink 3 from becoming long. In other words, the printer 1 contributes to suppressing the deterioration in the circulation performance.

In the above-described embodiment, the white ink 3 is an example of a “liquid” of the present disclosure. The nozzle group W1 is an example of a “first nozzle” of the present disclosure. The first flow path 50A is an example of a “first flow path” of the present disclosure. The nozzle group W2 is an example of a “second nozzle” of the present disclosure. The second flow path 60A is an example of a “second flow path” of the present disclosure.

The damper 34A is an example of a “first adjusting member” of the present disclosure. The damper 34B is an example of a “second adjusting member” of the present disclosure. The filter 38A is an example of a “first filter” of the present disclosure. The filter 38B is an example of a “second filter” of the present disclosure.

The point P12 is an example of a “first connection point” of the present disclosure. The point P22 is an example of a “second connection point” of the present disclosure. The connection flow path 73 is an example of a “first connection flow path” of the present disclosure.

The flow path 51A is an example of a “first partial flow path” of the present disclosure. The flow path 61A is an example of a “second partial flow path” of the present disclosure. The FE joint 36 is an example of an “intermediate member” of the present disclosure. The lower end 511 is an example of a “first downstream end” of the present disclosure. The lower end 611 is an example of a “second downstream end” of the present disclosure.

The end surface 36A is an example of an “end surface” of the present disclosure. The flow path 52 is an example of a “first wall” of the present disclosure. The flow path 62 is an example of a “second wall” of the present disclosure. The wall 73A is an example of a “first connection wall” of the present disclosure. The wall 73B is an example of a “second connection wall” of the present disclosure.

The point P51 is an example of a “first point” of the present disclosure. The point P56 is an example of a “second point” of the present disclosure. The point P61 is an example of a “third point” of the present disclosure. The point P66 is an example of a “fourth point” of the present disclosure.

The front-rear direction is an example of a “width direction” of the present disclosure. The wall 52B is an example of a “first facing wall” of the present disclosure. The wall 52D is an example of a “second facing wall” of the present disclosure. The wall 62B is an example of a “third facing wall” of the present disclosure. The wall 62D is an example of a “fourth facing wall” of the present disclosure.

The point P11 is an example of a “third connection point” of the present disclosure. The point P21 is an example of a “fourth connection point” of the present disclosure. The connection flow path 72 is an example of a “second connection flow path” of the present disclosure. The circulation pump 721 is an example of a “circulation pump” of the present disclosure.

The CPU 101 is an example of a “controller” of the present disclosure. The processing at S53 or S83 is an example of “circulation processing” of the present disclosure.

The nozzle surface 390 is an example of a “nozzle surface” of the present disclosure. The cap 41 is an example of a “cap” of the present disclosure. The waste liquid flow path 79 is an example of a “waste liquid flow path” of the present disclosure. The waste liquid pump 791 is an example of a “waste liquid pump” of the present disclosure.

The first valve 501 is an example of a “first valve” of the present disclosure. The second valve 601 is an example of a “second valve” of the present disclosure. The processing at S33 is an example of “first supply processing” of the present disclosure. The processing at S43 is an example of “second supply processing” of the present disclosure.

The manifold 30A is an example of a “first manifold flow path” of the present disclosure. The manifold 30B is an example of a “second manifold flow path” of the present disclosure. The connection flow path 74 is an example of a “third connection flow path” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. The various modifications may be combined with each other insofar as no contradictions arise also. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiment, another ink may be used in place of the white ink 3.

In the above-described embodiment, the ink pouch 23 is the ink cartridge. In contrast, the printer 1 may include a tank in place of the ink pouch 23. The ink pouches 24 to 28 may also be changed in a similar manner to the ink pouch 23.

In the above-described embodiment, the ink pouch 23 may be a sub-tank. In other words, the printer 1 may include a common main tank, and the white ink may be supplied to each of the ink pouches 23 and 24 from the common main tank. The printer 1 may include a first main tank and a second main tank, and supply the white ink to the ink pouch 23 from the first main tank and supply the white ink to the ink pouch 24 from the second main tank.

In the above-described embodiment, the printer 1 may include a single cartridge or a single main tank in place of the ink pouches 23 and 24. The printer 1 may further include two sub-tanks, and may supply the white ink to each of the two sub-tanks from the single cartridge or the single main tank. One of the sub-tanks corresponds to the ink pouch 23 shown in FIG. 9.

In the above-described embodiment, the printer 1 may include the single cartridge or the single main tank in place of the ink pouches 23 and 24. The printer 1 may further include one sub-tank, and may supply the white ink to the one sub-tank from the single cartridge or the single main tank. The sub-tank corresponds to the ink pouch 23 shown in FIG. 9. Furthermore, the printer 1 may include another connection flow path. In the connection flow path 71, the other connection flow path may connect the connection flow path 71 to each of the first flow path 50B and the second flow path 60B between the point P1 and the point P2. In other words, after the single flow path extends from the sub-tank, the single sub-tank may be connected to each of the nozzle groups W1 and W2 via the connection flow path 71, and may be connected to each of the nozzle groups W3 and W4 via the other connection flow path.

In the above-described embodiment, the printer 1 may include the single cartridge or the single main tank in place of the ink pouches 23 and 24. The printer 1 may further include the single sub-tank and may supply the white ink from the single cartridge or the single main tank to the single sub-tank. The sub-tank corresponds to the ink pouch 23 shown in FIG. 9. Furthermore, the printer 1 may include the other connection flow path. The other connection flow path and the connection flow path 71 are connected to the sub-tank and extend from the sub-tank. The other connection flow path branches into the first flow path 50B and the second flow path 60B. The first flow path 50B is connected to the sub-tank via the other connection flow path. The second flow path 60B is connected to the sub-tank via the other connection flow path. In other words, the single sub-tank may be connected to each of the nozzle groups W1 and W2 via the connection flow path 71, and connected to each of the nozzle groups W3 and W4 via the other connection flow path.

In the above-described embodiment, the nozzle group W1 may be the single nozzle 391. The nozzle group W2 may be the single nozzle 391.

In the above-described embodiment, the printer 1 may include a differential pressure valve in place of or in addition to the damper 34A. In a similar manner, the printer 1 may include differential pressure valves in place of or in addition to the dampers 34B to 34D. The differential pressure valve is a type of adjusting member. The differential pressure valve includes a spring and a valve body. In the differential pressure valve, an open and closed state of the valve body is controlled by an urging force of the spring in accordance with a pressure acting on the differential pressure valve. In this way, the differential pressure valve adjusts an amount of ink flowing from the differential pressure valve.

In the above-described embodiment, the printer 1 may omit the connection flow path 71. In other words, the first flow path 50A and the second flow path 60A may be connected directly to the ink pouch 23, rather than via the connection flow path 71.

In the above-described embodiment, the first flow path 50A and the second flow path 60A may be connected to mutually different ink pouches. For example, the first flow path 50A may be connected to the ink pouch 23, and the second flow path 60A may be connected to the ink pouch 24.

In the above-described embodiment, the nozzle group W1 and the nozzle group W2 may be disposed on mutually different heads. For example, the nozzle group W1 may be disposed on the head 3A, and the nozzle group W2 may be disposed on the head 3B.

In the above-described embodiment, the connection flow path 73 may be formed in a member different from the FE joint 36. For example, the connection flow path 73 may be formed in the FE plate 37. The connection flow path 73 may be formed by a tube.

In the above-described embodiment, the connection flow path 73 may be formed in the FE joint 36 at a section different from the end surface 36A. For example, the connection flow path 73 may be formed as a result of providing a through hole in a central portion of the FE joint 36 in the up-down direction.

In the above-described embodiment, the end surface 36A need not necessarily be arranged alongside each of the filters 38A to 38D in the up-down direction.

In the above-described embodiment, the point P51 and the point P56 may be disposed on the rear end of the flow path 52, may be disposed on the left end of the flow path 52, or may be disposed on the front end of the flow path 52.

In the above-described embodiment, the point P61 and the point P66 may be disposed on the rear end of the flow path 62, may be disposed on the left end of the flow path 62, or may be disposed on the front end of the flow path 62.

In the above-described embodiment, the width W13 may be the same as the width W11, or may be larger than the width W11. The width W13 may be the same as the width W12, or may be larger than the width W12.

In the above-described embodiment, the printer 1 may omit the connection flow path 73. The printer 1 may omit the connection flow path 74.

In the above-described embodiment, the circulation pump 721 may be disposed in one of the flow paths of the first circulation flow path. For example, the circulation pump 721 may be disposed between the point P11 and the point P12 of the first flow path 50A in the first supply direction. The circulation pump 721 may be disposed between the point P21 and the point P22 of the second flow path 60A in the second supply direction. The circulation pump 721 may be disposed in the connection flow path 73.

In the above-described embodiment, the printer 1 may omit the first valve 501. The printer 1 may omit the second valve 601.

In the above-described embodiment, in the processing at S33, the CPU 101 may drive the waste liquid pump 791 in the state in which both the first valve 501 and the second valve 601 are open. In this case, the CPU 101 may omit the processing at S41 to S43.

In the above-described embodiment, each of the filters 38A to 38D may be supported by the FE plate 37. Each of the filters 38A to 38D may be supported by FE joint 36.

The filters 38A and 38B may be configured by a single filter. In other words, the filters 38A and 38B may be joined to each other. In a similar manner, the filters 38C and 38D may be configured by a single filter. All of the filters 38A to 38D may be configured by a single filter.

In the above-described embodiment, the printer 1 may omit the FE plate 37.

In the above-described embodiment, a sum total of the first predetermined amount, the second predetermined amount, and the fourth predetermined amount is preferably greater than the drive amount of the extent at which the first flow path 50A and the second flow path 60A are filled with the white ink 3. In other words, at a time point of the processing at S63, the first flow path 50A and the second flow path 60A are preferably filled with the white ink 3.

In the above-described embodiment, the first predetermined amount may be smaller than the drive amount of the extent at which the first flow path 50A is filled with the white ink 3. For example, the first predetermined amount is preferably greater than a drive amount of an extent at which, in the first flow path 50A, the white ink 3 is filled between the point P2 and the point P11. The second predetermined amount may be smaller than the drive amount of the extent at which the second flow path 60A is filled with the white ink 3. For example, the second predetermined amount is preferably greater than a drive amount of an extent at which, in the second flow path 60A, the white ink 3 is filled between the point P2 and the point P21.

In the above-described embodiment, the CPU 101 may change a processing order within a range that contradictions do not arise.

In place of the CPU 101, a microcomputer, application specific integrated circuits (ASICs), a field programmable gate array (FPGA), and the like may be used as the processor. The main processing may be executed as distributed processing by a plurality of processors.

It is sufficient that a non-transitory storage medium, such as the flash memory 102, for example, be a storage medium capable of storing information regardless of a period of storage of the information. The non-transitory storage medium need not necessarily include a transitory storage medium. The transitory storage medium is a transmitted signal, for example. The control program may be downloaded from a server connected to a network (not shown in the drawings), namely, may be transmitted as a transmission signal, and stored in the flash memory 102. In this case, it is sufficient that the control program be saved in a non-transitory storage medium, such as an HDD included in the server.

What is claimed is:

1. An inkjet printer comprising:
a first flow path connected to a first nozzle configured to eject a liquid;
a second flow path connected to a second nozzle configured to eject the liquid;
a first adjusting member being a damper or a differential pressure valve disposed in the first flow path;
a second adjusting member being a damper or a differential pressure valve disposed in the second flow path;
a first filter disposed downstream of the first adjusting member in a first supply direction in the first flow path, the first supply direction being a direction along flow of the liquid through the first flow path toward the first nozzle;
a second filter disposed downstream of the second adjusting member in a second supply direction in the second flow path, the second supply direction being a direction along flow of the liquid through the second flow path toward the second nozzle; and
a first connection flow path connecting a first connection point and a second connection point to each other, the first connection point positioned between the first adjusting member and the first filter in the first supply direction in the first flow path, and the second connection point positioned between the second adjusting member and the second filter in the second supply direction in the second flow path.

2. The inkjet printer according to claim 1, further comprising:
an intermediate member disposed between the first adjusting member and the first filter in the first supply direction and between the second adjusting member and the second filter in the second supply direction, and including a first partial flow path being a part of the first flow path and a second partial flow path being a part of the second flow path, wherein
the first connection flow path is formed at the intermediate member.

3. The inkjet printer according to claim 2, wherein
the intermediate member includes an end surface having a first downstream end in the first supply direction of the first partial flow path and a second downstream end in the second supply direction of the second partial flow path, and
the first connection flow path is formed at the end surface of the intermediate member.

4. The inkjet printer according to claim 3, wherein
the end surface and the first filter are arranged alongside each other in an order of the end surface and the first filter from upstream to downstream in the first supply direction, and
the end surface and the second filter are arranged alongside each other in an order of the end surface and the second filter from upstream to downstream in the second supply direction.

5. The inkjet printer according to claim 3, wherein
the intermediate member includes
a first wall being a part of the first flow path and protruding from the end surface,
a second wall being a part of the second flow path and protruding from the end surface,
a first connection wall being a part of the first connection flow path and protruding from the end surface, and
a second connection wall being a part of the first connection flow path and protruding from the end surface,
when seen from a direction of protrusion of the first wall from the end surface, the first wall extends from a first point to a second point around a periphery of the first downstream end,
when seen from a direction of protrusion of the second wall from the end surface, the second wall extends from a third point to a fourth point around a periphery of the second downstream end,
the first connection wall is connected to the first wall at the first point and is connected to the second wall at the third point,
the second connection wall is connected to the first wall at the second point and is connected to the second wall at the fourth point, and
the first connection wall and the second connection wall face each other with an interval therebetween.

6. The inkjet printer according to claim 5, wherein
each of the first point and the second point is positioned at an end of the first wall in a direction from the first wall toward the second wall, and
each of the third point and the fourth point is positioned at an end of the second wall in a direction from the second wall toward the first wall.

7. The inkjet printer according to claim 6, wherein
a width direction is a direction along a facing the first connection wall and the second connection wall face each other,
the first wall includes a first facing wall and a second facing wall facing each other in the width direction,
the second wall includes a third facing wall and a fourth facing wall facing each other in the width direction, and
a width between the first connection wall and the second connection wall in the width direction is smaller than a width between the first facing wall and the second facing wall in the width direction, and smaller than a width between the third facing wall and the fourth facing wall in the width direction.

8. The inkjet printer according to claim 1, further comprising:
a second connection flow path connecting a third connection point and a fourth connection point to each other, the third connection point being positioned upstream of the first adjusting member in the first supply direction in the first flow path, and the fourth connection point being positioned upstream of the second adjusting member in the second supply direction in the second flow path;
a circulation pump provided in a first circulation flow path including the first flow path, the second flow path, the first connection flow path, and the second connection flow path; and
a controller, wherein
the controller drives the circulation pump and performs a circulation processing of causing the liquid to circulate in the first circulation flow path.

9. The inkjet printer according to claim 8, further comprising:
a cap configured to come into contact with a nozzle surface including the first nozzle and the second nozzle disposed thereon, and configured to switch between a capped state of covering the first nozzle and the second nozzle, and an uncapped state of being separated from the nozzle surface;
a waste liquid pump provided in a waste liquid flow path connected to the cap;
a first valve disposed upstream of the third connection point in the first supply direction in the first flow path; and
a second valve disposed upstream of the fourth connection point in the second supply direction in the second flow path, wherein
the controller
drives the waste liquid pump in a state in which the cap is in the capped state and the first valve is open and the second valve is closed, and performs a first supply processing of causing the liquid to flow in the first supply direction in the first flow path, and
drives the waste liquid pump in a state in which the cap is in the capped state and the first valve is closed and the second valve is open, and performs a second supply processing of causing the liquid to flow in the second supply direction in the second flow path, and
in the circulation processing, the controller further drives the circulation pump in a state in which the first valve is closed and the second valve is closed, and causes the liquid to circulate in the first circulation flow path.

10. The inkjet printer according to claim 8, further comprising:
a first manifold flow path disposed downstream of the first filter in the first supply direction in the first flow path, and configured to guide the liquid flowing in the first supply direction in the first flow path to the first nozzle;
a second manifold flow path disposed downstream of the second filter in the second supply direction in the second flow path, and configured to guide the liquid flowing in the second supply direction in the second flow path to the second nozzle; and
a third connection flow path connecting the first manifold flow path and the second manifold flow path to each other, wherein
in the circulation processing, the controller drives the circulation pump and causes the liquid to circulate in the first circulation flow path, and causes the liquid to circulate in a second circulation flow path including the first flow path, the second flow path, the second connection flow path, and the third connection flow path.

11. An inkjet head comprising:
a first flow path connected to a first nozzle configured to eject a liquid;
a second flow path connected to a second nozzle configured to eject the liquid;
a first adjusting member being a damper or a differential pressure valve disposed in the first flow path;
a second adjusting member being a damper or a differential pressure valve disposed in the second flow path;
a first filter disposed downstream of the first adjusting member in a first supply direction in the first flow path, the first supply direction being a direction along flow of the liquid through the first flow path toward the first nozzle;
a second filter disposed downstream of the second adjusting member in a second supply direction in the second flow path, the second supply direction being a direction along flow of the liquid through the second flow path toward the second nozzle; and
a first connection flow path connecting a first connection point and a second connection point to each other, the first connection point being positioned between the first adjusting member and the first filter in the first supply direction in the first flow path, and the second connection point being positioned between the second adjusting member and the second filter in the second supply direction in the second flow path.
